(19) United States
(12) Patent Application Publication
(10) Pub. No.: US 2025/0377009 A1
(43) Pub. Date: Dec. 11, 2025

(54) CAP ASSEMBLY FOR TOILET

(71) Applicant: M3WE, Inc., Shorewood, IL (US)

(72) Inventor: Michael J. Schuster, Shorewood, IL (US)

(21) Appl. No.: 19/240,901

(22) Filed: Jun. 17, 2025

Related U.S. Application Data
(63) Continuation-in-part of application No. 17/740,621, filed on May 10, 2022, now Pat. No. 12,359,417.

(51) Int. Cl. F16B 41/00; E03D 11/16

(52) U.S. Cl. CPC F16B 41/005; E03D 11/16

(57) ABSTRACT

A cap assembly for a toilet. The cap assembly is configured to be operatively placed with respect to a toilet to shield from view at least portions of anchor bolts, and components that secure the anchor bolts to thereby maintain the toilet in an operative position with respect to a mounting surface. The cap assembly may additionally incorporate one or more functional features.

### BACKGROUND OF THE INVENTION

### CROSS-REFERENCE TO RELATED APPLICATIONS

This application is a continuation-in-part of U.S. patent application Ser. No. 17/740,621, filed May 10, 2022.

### FIELD OF THE INVENTION

This invention relates to cap assemblies, as used at locations on toilets where anchor bolts are secured, to improve aesthetics and/or perform one or more additional functions.

### BACKGROUND ART

Anchor bolts are used to maintain a toilet on a support surface therefor. The anchor bolts cooperate with a closet collar that transitions to a drain pipe and has a flange that is fixed in relationship to the support surface. It is common to use a wax component to seal between an upper surface of the flange and the toilet to prevent communication of sewer gas into a space and confine sewage discharge to the drain pipe.

Closet collar flanges have a number of different configurations, including one form which has slots or channels to receive the anchor bolt heads whereby the flange can be fixed to the support surface without the anchor bolt heads being wedged so as to create a gap between the bottom of the flange and support surface.

The closet collar flange is typically attached to the support surface with screws, with the anchor shanks projecting upwardly therefrom to be directed into and through openings on a mounting portion of a toilet. Nuts engage the threaded shanks of the anchor bolts and, when tightened, draw the toilet down to the support surface, thereby creating a seal between the toilet and the closet collar flange. The nuts are ideally tightened to the point that they cause a positive seal to be created between the toilet and closet collar flange and at the same time cause the toilet to be stably mounted with respect to the support surface.

To create the desired captive force between the toilet and the closet collar flange, typically the nuts on the anchor bolts are tightened using a wrench. Using a wrench creates a number of potential problems. Since sealing structures generally do not provide a substantial resistance to tightening, nuts on anchor bolts may be easily overtightened when using a wrench capable of applying a substantial torque. Thus, installers may, out of caution, tend to tighten the nuts inadequately-fearing cracking the porcelain on the toilet. There is a further danger of overtightening the nuts that causes cracks to be produced in the closet collar flange, thereby potentially compromising the stability of the toilet mount and the integrity of the seal between the toilet and flange.

Still further, the use of a large wrench may result in repeated contact between the wrench and the porcelain toilet surfaces, which could damage the surface thereof and potentially create cracks. Further, an installer's hand may be inadvertently compressed between the wrench and toilet as the wrench is manipulated.

In a common anchor bolt construction, the anchor bolt shank extends upwardly to beyond an upwardly facing surface on a mounting portion of the toilet. A washer is utilized to bear on the upwardly facing surface. A nut is threaded onto the exposed shank portion of the anchor bolt and tightened to produce a downward force on the upwardly facing toilet surface through the washer.

Once the nuts are tightened, it is common to use a decorative cap to make the region around the anchor bolts easier to clean and to produce a more aesthetically pleasing appearance. Caps are typically offered in plastic or porcelain in an inverted cup shape which is placed over the exposed anchor bolt shank region, including the nut threadably engaged therewith and any underlying washer.

Anchor bolts come in different thread sizes and are commonly made from metal materials such as steel or brass. Non-metal anchor bolts are also used. Typically, the anchor bolts range from ¼ inch to 5/16 inch in diameter and have overall lengths between 2 and 3.5 inches. The different lengths are provided to accommodate different vertical locations of the fixed closet collar flange. For example, the underside of the flange, when fixed, may be placed facially against a surface that is at the same height as the finished floor surface. With this site condition, generally ½ to 1 inch of a two-inch bolt needs to be removed to allow a conventional-type cap to be placed over the free end region of the bolt shank and the nut thereon.

In other applications, the closet collar flange may be recessed below the finished floor surface, such as by 2.5 inches, thereby requiring the longer 3.5 inch anchor bolts. Generally, if the closet collar flange extends to above the finished floor surface, or is recessed less than 2.5 inches below the floor surface, a length of the free end region of the bolt will have to be removed to allow a conventional-type cap to be utilized.

Once the nuts are tightened on the anchor bolts, it may be difficult to cut the anchor bolt shank to remove an excess length thereof, particularly if the anchor bolts are made from metal. Toilets are commonly placed in compact spaces between walls, cabinets, bathtubs/showers, etc. This is complicated by the fact that the anchor bolt shanks extend upwardly from the mounting portion of the toilet close to the wall transitioning up to define the bowl region.

A well-known cutting technique utilizes a saw blade that is moved back and forth to progressively sever the anchor bolt shank. Installers, particularly end users, may not have appropriate saws on hand to effect cutting. Even skilled persons contend with the challenge of maneuvering a saw blade back and forth in tight quarters without inadvertently and undesirably impacting the porcelain exterior of the toilet. Further, during the hand maneuvering the saw blade is likely to be undesirably impacted with hard porcelain as cutting is carried out. Again, the problem of pinching of the installer's hand between the tool and toilet is contended with.

As a result of these problems, it is common for many persons to leave the anchor bolt shanks with an excess length at the free end region thereof. In this condition, a cap may not be practically usable or, if used, may be suspended unstably on the free end of the anchor bolt shank. As a result, the region around the anchoring locations is prone to becoming unsanitary in addition to being unsightly.

Given the above problems, a number of attempted solutions have been developed to eliminate the need to a cut anchor bolts. Generally, the lack of full range of heights and adjustability to cover from 1 inch to 3.5 inches have added complexity and cost to installation without a full range of functionality.

One proposed solution has been to provide the anchor bolt shanks with strategically located weakening points whereby selected, discrete lengths of the shank can be broken off. However, if the shank is inadvertently broken off at the wrong location, additional cutting may be required.

Further, this latter design generally requires a user to apply the break off force using a wrench or a like leveraging tool to apply an adequate force to the bolt shank to effect its fracture. Maneuvering of the wrench may result in inadvertent contact with the porcelain surfaces of the toilet, which may inflict damage thereto. A similar result may occur if the wrench slips from the installer's hands during this process.

Still further, the force applied to break off the anchor bolt shank may loosen the connection between the head region of the anchor bolt and the closet collar flange. This may cause the head region of the anchor bolt to disengage from the closet collar flange, whereby it is no longer appropriately stably bearing on a downwardly facing surface associated with the flange. If this occurs, the nuts may have to be separated from their respective anchor bolt, after which the toilet is elevated and the anchor bolts reengaged at the head region. Essentially, this requires a complete re-anchoring of the toilet.

Nylon plastic anchor bolts and nuts have been used to address the aforementioned cutting problem. However, using conventional tools, the installer still faces the same issues associated with the cramped space in which maneuvering of the tools is difficult. Still further, the tools used to cut plastic bolt shanks may induce vibrations and/or wedge the anchor bolts such that the head region disengages from the closet collar flange, as discussed above.

Closet collars and closet collar flanges are commonly constructed of PVC or ABS plastic or cast iron, stainless steel, or cold-rolled metal. Closet collar flanges, regardless of the material from which they are constructed, tend to break around slotted areas, that are used to accommodate anchor bolts, and around openings for fasteners that are directed through closet collar flanges and tightened into a subjacent surface. When the anchor bolts are over-tightened, or the toilet is rocked in use, it can put undue stresses on the flange, particularly where it is compromised by slots or openings to accept fasteners. As a result, anchor bolts may be drawn through closet collar flanges made from thin metal or may crack cast iron or plastic flanges.

Further, if a seal leaks over a metal closet collar flange, the flange material may rust away, eventually allowing the anchor bolt to pull through the flange.

A failed closet collar flange may necessitate a replacement. Alternatively, repair flanges are fastened over the top of an already in place closet collar. Typically, the repair flanges are fixed using threaded fasteners directed through the repair flange and the existing closet collar flange to engage the support surface for the toilet. In the event that a repair flange is utilized, to avoid leakage of sewer gas, at least one sealing component is provided between the existing closet collar flange and the repair flange and similarly between the repair flange and the toilet.

Repair flanges are offered such that installers may opt to, or inadvertently, connect the repair flange to the existing closet collar flange without any sealing component therebetween. Thus, this region is prone to allowing migration of sewer gas into a space.

In spite of the vast number of toilets that are installed worldwide, and the ongoing continuous challenges in construction and installation, as described above, the industry has failed to offer adequate solutions to many of these problems, whereby installers must continue to contend with them.

The industry is constantly challenged to improve the aesthetics of toilets where the anchor bolts are located. Commonly, long anchor bolts are offered as generic components that can be adapted to different site conditions. The shanks of the anchor bolts project upwardly from a mounting portion of the toilet through which the anchor bolts extend. The threaded shank allows an engaged nut to be advanced therealong to capture different thicknesses between the head of the anchor bolt and the top surface of the mounting portion of the toilet. In most instances, a substantial length of the shank will project upwardly above the nut after the anchor bolt is secured. Thus, at the site of each anchor bolt, there is generally an upwardly projecting anchor bolt shank, at least one washer, and at least one nut that remain visible when the toilet is finally secured. In the absence of taking some additional steps, this collection of components remains visible and is generally unsightly. This problem is aggravated by the fact that any metal components used tend to rust and corrode over time.

While professional installers generally will remove any extended length of the anchor bolt shank, less skilled persons tend to find it difficult to cut the shank, particularly fearing that they might inflict damage upon, or alter the appearance of, the oftentimes expensive ceramic material making up the bowl and the mounting portion therefor.

One common attempted solution to the aesthetics problem is the use of a simple inverted, cup-shaped cap/cover. The cap/cover has a rim with a sufficient diameter to extend around all of the mounting components which move into a cavity bounded by a wall on the cap/cover with the cap/cover in place.

In its simplest form, this cap/cover has several limitations. Since the cap/cover is lowered over the anchoring components so that the rim simply rests upon a surface on the mounting portion of the toilet, it readily shifts and may be inadvertently separated from the toilet during normal use, or when cleaning.

Another problem is that the depth of the “cup” dictates the maximum length of the projecting anchor bolt shank that will be accommodated. Thus, it may be necessary to offer caps/covers with a range of depths. Larger sizes are often unsightly and more prone to being impacted and unintentionally shifted or separated. They may also overall negatively affect the aesthetics of a bathroom.

It is known to provide snap-fitted caps/covers and ones that are threadably engaged with special components incorporated into or around the anchor bolt. These designs have proven to be effective but inherit certain limitations of the simple cup-shaped cap/cover, as described above.

Further, the snap-fit or threaded connection of a cap/cover generally requires the provision of additional components, which introduces the problem of having to handle more parts. Further, installation may be complicated by the particular design requiring these additional parts.

Most installations use as a covering component the basic cup-shaped configuration. Because of the difficulty and/or inconvenience in making some adaptations to improve this basic design, a very large percentage of anchor bolts in businesses and private residences remain exposed and unsightly. This is in spite of the fact that the anchor bolts prominently stand out on most toilets by reason of their required location.

Efforts to date to improve aesthetics, when they are made, generally involve obscuring the presence of the mounting bolts as opposed to improving the visual appeal thereof.

Another problem that has existed in the industry is controlling the orientation of the upwardly projecting anchor bolts during placement of the toilet. In a conventional design, the head of the anchor bolt is captured, but only loosely held, between a closet collar and a subjacent surface. While the opening through the mounting portion of the toilet is oversized to accommodate the shank of the anchor bolts, given the weight of the toilet, it may still be difficult to simultaneously align the anchor bolts on opposite sides of the toilet bowl. Multiple attempts may be required to effect this alignment, which adds to installation time and may contribute to installer fatigue when maneuvering often relatively heavy toilets during successive installations.

The industry is commonly seeking better and more efficient ways to facilitate toilet installations while at the same time improving aesthetics thereof without requiring complicated components or procedures.

### SUMMARY OF THE INVENTION

In one form, the invention is directed to a cap assembly for use with a toilet. The toilet is mounted in an operative position on a support and maintained in the operative position using at least one anchor bolt having an elongate shank that projects into a mounting portion on the toilet so that a free end of the elongate shank is exposed. A fixing assembly engages the elongate shank so as to block movement of the mounting portion along a length of the elongate shank to beyond the free end of the elongate shank. The cap assembly includes first and second parts that are placed in an assembled and operative state wherein exposed portions on each of the first and second parts cooperatively overlie and block from view at least portions of the elongate shank and the fixing assembly.

In one form, the first and second parts are connected to each other.

In one form, the first and second parts are releasably connected to each other.

In one form, there are cooperating connectors on one of the first and second parts and the elongate shank.

In one form, there are cooperating connectors on one of the first and second parts and the fixing assembly.

In one form, there are cooperating connectors on the other of the first and second parts and the fixing assembly.

In one form, there are cooperating connectors on the other of the first and second parts and the elongate shank.

In one form, there are cooperating connectors on the first and second parts at a first location along the length of the elongate shank. A portion of one of the first and second parts extends away from the first location and the other of the first and second parts towards the free end of the elongate shank. A portion of the other of the first and second parts extends away from the first location and the one of the first and second parts away from the free end of the elongate shank.

In one form, with the first and second parts in the assembled state, the cap assembly has first and second ends spaced along the length of the elongate shank. There are cooperating connectors on the first and second parts that interact at a location spaced from each of the first and second ends of the cap assembly.

In one form, the first and second parts are directly connected to each other through cooperating connectors configured to make a releasable press fit connection.

In one form, the first and second parts are directly connected to each other.

In one form, the cooperating connectors are configured to be threadably engaged.

In one form, the cooperating connectors are configured to be press fit together.

In one form, one of the first and second parts has a wall that has a cup shape defining a cavity in which at least a portion of the fixing assembly resides.

In one form, the other of the first and second parts has a substantially cylindrical outer surface that extends around a length portion of the elongate shank.

In one form, the wall has an effective outer diameter in relationship to a lengthwise axis of the elongate shank. The substantially cylindrical outer surface has an effective average diameter. The effective outer diameter of the wall is at least two times greater than the effective outer diameter of the cylindrical outer surface.

In one form, one of the first and second parts has a cylindrical wall which conformingly surrounds a length portion of the elongate shank and an end wall that overlies the free end of the elongate shank.

In one form, one of the first and second parts projects in cantilever fashion from the other of the first and second parts.

In one form, the first and second parts are directly connected to each other through cooperating connectors configured to make a snap-fit connection.

In one form, one of the parts has a three-dimensional depiction of an object thereon.

In one form, the cap assembly is provided in combination with a third part that is interchangeably usable in place of one of the first and second parts. The third part is different than the one of the first and second parts by reason of at least one of: a) having a different size; b) having a different shape; c) having a different color; and d) having a different appearance.

In one form, the cap assembly is provided in combination with a toilet, at least one anchor bolt, and a fixing assembly.

In one form, the invention is directed to a first cap assembly for use with a toilet mounted in an operative position on a support and maintained in the operative position using at least one anchor bolt having an elongate shank that projects through a mounting portion on the toilet so that a length portion of the shank extending above the mounting portion up to a free end of the elongate shank is exposed. A fixing assembly engages the elongate shank so as to block movement of the mounting portion along a length of the elongate shank to beyond the free end of the elongate shank. The first cap assembly includes a wall that defines a cavity into which at least a part of each of the fixing assembly and the length portion of the elongate shank is received with the first cap assembly in an operative state. The wall has a stepped outer diameter with a larger diameter portion and a smaller diameter portion. The smaller diameter portion projects away from the larger diameter portion in a direction towards the free end of the elongate shank.

In one form, the smaller diameter portion extends up to the free end of the shank and overlies the free end of the elongate shank.

In one form, the smaller diameter portion conformingly surrounds at least a part of the length portion of the elongate shank.

In one form, the smaller diameter portion is threadably engaged with the elongate shank.

In one form, the smaller diameter portion has a substantially uniform thickness.

In one form, the first cap assembly is provided in combination with a second cap assembly that is usable interchangeably in place of the first cap assembly. The second cap assembly is different than the first cap assembly by reason of at least one of: a) having a different size; b) having a different shape; c) having a different color; and d) having a different appearance.

In one form, the second cap assembly has a wall with a stepped outer diameter with a larger diameter portion and a smaller diameter portion. The smaller diameter portion on the second cap assembly projects away from the large diameter portion of the second cap assembly in a direction towards the free end of the elongate shank. The smaller diameter portions on the first and second cap assemblies extend away from respective larger diameter portions distances that are different.

In one form, the first and second cap assemblies in respective operative states overlie the free end of the elongate shank.

### BRIEF DESCRIPTION OF THE DRAWINGS

FIG. 1 is a schematic representation of a toilet to be mounted on a support surface and with which the present invention can be used;

FIG. 2 is a schematic representation of a system, according to the invention, including a closet collar, anchor bolt, cap support assembly connectable to the anchor bolt, and a cap connectable to the cap support assembly;

FIG. 3 is an exploded perspective view of one exemplary form of system as shown in FIG. 2;

FIG. 4 is a view as in FIG. 3 with the components in an assembled relationship;

FIG. 5 is an enlarged, plan view of a key slot on a closet collar that can be engaged with the anchor bolt as shown in FIGS. 3 and 4;

FIG. 6 is a fragmentary, cross-sectional view of a mounting portion of a toilet on a support surface and with the inventive system in FIG. 3 utilized to effect mounting thereof;

FIG. 7 is a view as in FIG. 6 wherein a closet collar on the system is at a different vertical location relative to a support surface for the toilet than in FIG. 6;

FIG. 8 is a side elevation view of the assembled components in FIG. 4;

FIG. 9 is a cross-sectional view of the components taken along line 9-9 of FIG. 8;

FIG. 10 is a perspective view of the anchor bolt making up part of the system in FIG. 3;

FIG. 11 is a side elevation view of the anchor bolt in FIG. 10;

FIG. 12 is a perspective view of a stabilizing component, on the system in FIG. 3, and connectable to the anchor bolt to stabilize the anchor bolt with respect to the closet collar;

FIG. 13 is a side elevation view of the stabilizing component in FIG. 12;

FIG. 14 is a cross-sectional view of the stabilizing component taken along line 14-14 of FIG. 13;

FIG. 15 is a view as in FIG. 13 of a modified form of stabilizing component;

FIG. 16 is a perspective view of a nut assembly making up the cap support assembly on the system in FIG. 3;

FIG. 17 is a plan view of the nut assembly in FIG. 16;

FIG. 18 is an end elevation view of the nut assembly in FIGS. 16 and 17;

FIG. 19 is a cross-sectional view of the nut assembly taken along line 19-19 of FIG. 17;

FIG. 20 is a perspective view of a cap on the inventive system in FIG. 3;

FIG. 21 is a side elevation view of the cap in FIG. 20;

FIG. 22 is a bottom view of the cap in FIGS. 20 and 21;

FIG. 23 is a cross-sectional view of the cap taken along line 23-23 of FIG. 22;

FIG. 24 is a plan view of a cutting tool used to sever a discrete length of the anchor bolt shank;

FIG. 25 is a view as in FIG. 24 showing the cutting tool being moved back and forth against an anchor bolt shank;

FIG. 26 is a view as in FIG. 3 and showing a modified form of the inventive system;

FIG. 27 is a view as in FIG. 26 with the components in assembled relationship;

FIGS. 28 and 29 correspond respectively to FIGS. 6 and 7 and with the modified system in FIGS. 26 and 27 mounting the toilet to the support surface;

FIG. 30 is a side elevation view of the components in FIG. 27;

FIG. 31 is a cross-sectional view of the components taken along line 31-31 of FIG. 30;

FIG. 32 is an enlarged, perspective view of one of two joinable parts making up the anchor bolt in FIGS. 27-31;

FIG. 33 is a plan view of the component in FIG. 32;

FIG. 34 is a side elevation view of the component in FIGS. 32 and 33;

FIG. 35 is a plan view of the component joined to the components in FIGS. 32-34 to make up the anchor bolt;

FIG. 36 is a bottom view of the component in FIG. 35;

FIG. 37 is a view as in FIG. 20 and showing a modified form of cap, according to the invention;

FIG. 38 is a side elevation view of the cap in FIG. 37;

FIG. 39 is a bottom perspective view of the cap in FIGS. 37 and 38;

FIG. 40 is a bottom view of the cap in FIGS. 37-39;

FIG. 41 is a cross-sectional view of the cap taken along line 41-41 of FIG. 40;

FIG. 42 is a cross-sectional view of the cap taken along line 42-42 of FIG. 40 and additionally showing the nut assembly in FIGS. 16-18, threadably engaged with a length of an anchor bolt, and operatively connected therewith;

FIG. 43 is a fragmentary view showing cooperating portions of the cap and nut assembly as the cap is being directed into fully assembled relationship with the nut assembly;

FIG. 44 is a view as in FIG. 43 with the cap in fully assembled relationship with the nut assembly;

FIG. 45 is a top perspective view of a repair flange, according to the invention, usable as in conjunction with an existing closet collar flange;

FIG. 46 is a bottom perspective view of the repair flange in FIG. 45;

FIG. 47 is a bottom view of the repair flange in FIGS. 45 and 46;

FIG. 48 is a cross-sectional view of the anchor bolt, taken along line 48-48 of FIG. 9 and usable in conjunction with the repair flange in FIGS. 45-47;

FIG. 49 is a cross-sectional view of the repair flange taken along line 49-49 of FIG. 47;

FIG. 50 is a view of the repair flange as in FIG. 45 with a pair of anchor bolts operatively connected thereto;

FIG. 51 is an exploded perspective view of the components in FIG. 50;

FIG. 52 is a bottom view of the components in FIG. 50;

FIG. 53 is a cross-sectional view of the repair flange and operatively connected anchor bolts taken along line 53-53 of FIG. 52;

FIG. 54 is a fragmentary, partially exploded, perspective view showing the repair flange in FIGS. 45-53, with a seal component on the top thereof and anchor bolts operatively connected thereto, and fixed to an existing closet collar in relationship to a mounting portion of a toilet spaced above a support surface for the toilet;

FIG. 55 is an exploded view of the components in FIG. 54;

FIG. 56 is a cross-sectional view of the components in FIG. 54 taken along line 56-56 therein;

FIG. 57 is a top perspective view of a modified form of repair flange, according to the invention, and having a body with an over-molded sealing component;

FIG. 58 is a reduced, top view of the repair flange in FIG. 57;

FIG. 59 is a cross-sectional view of the repair flange taken along line 59-59 of FIG. 58;

FIG. 60 is a bottom view of the repair flange in FIGS. 57-59;

FIG. 61 is an exploded perspective view of the repair flange body and over-molded sealing component as shown in FIGS. 57-60;

FIG. 62 is a top view of the body on the repair flange in FIGS. 57-61;

FIG. 63 is a side elevation view of the body in FIG. 62;

FIG. 64 is a bottom view of the body in FIGS. 62 and 63;

FIG. 65 is a plan view of the sealing component on the repair flange in FIGS. 57-61;

FIG. 66 is a side elevation view of the sealing component in FIG. 65;

FIG. 67 is a bottom perspective view of the sealing component in FIGS. 65 and 66;

FIG. 68 is a bottom view of the sealing component in FIGS. 65-67;

FIG. 69 is a perspective view of an alternative form of cutting tool, corresponding to that in FIG. 24;

FIG. 70 is a perspective view of a separable, elongate, flexible cutting element making up part of the cutting tool in FIG. 69;

FIG. 71 is a side elevation view of the elongate flexible cutting element in FIG. 70;

FIG. 72 is a side elevation view of the cutting tool in FIG. 69;

FIG. 73 is a plan view of the cutting tool in FIGS. 69 and 72;

FIG. 74 is a cross-sectional view of the cutting tool taken along line 74-74 of FIG. 72;

FIG. 75 is a flow diagram representation of a method of mounting a toilet to a support surface, according to the invention;

FIG. 76 is a schematic representation of a cap assembly, according to the present invention, in relationship to a toilet mounting portion and components used to fix the mounting portion to a support surface for the toilet;

FIG. 77 is a schematic representation showing additional details of the anchor bolt in FIG. 76;

FIG. 78 is a fragmentary elevation view of a toilet mounting portion anchored in place using a conventional anchor bolt and components to secure the anchor bolt;

FIG. 79 is a view of the components in FIG. 78 from a different perspective;

FIG. 80 is an enlarged, cross-sectional view of the components taken along line 80-80 of FIG. 78;

FIG. 81 is an elevation view of an alternative form of washer, as used in association with the anchor bolt, as shown in FIGS. 78-80;

FIG. 82 is an elevation view of a conventional cap/cover for an anchor bolt;

FIG. 83 is a cross-sectional view of the cap/cover taken along line 83-83 of FIG. 82;

FIG. 84 is a view as in FIG. 82 showing a modified form of cap/cover;

FIG. 85 is a cross-sectional view of the cap/cover taken along line 85-85 of FIG. 84;

FIG. 86 is a schematic representation of one form of the inventive cap assembly and including first and second shielding parts;

FIG. 87 is a schematic representation showing connectors cooperating between the first and second parts in FIG. 86;

FIG. 88 is a schematic representation showing connectors cooperating between each of the first and second parts in FIG. 86 and an anchor bolt shank;

FIG. 89 is a schematic representation showing connectors cooperating between each of the first and second parts in FIG. 86 and the fixing assembly depicted schematically in FIG. 76;

FIG. 90 is an exploded perspective view of one exemplary form of cap assembly, as shown schematically in FIGS. 76 and 86, in relationship to an anchor bolt and fixing assembly, as shown in FIG. 76;

FIG. 91 is an elevation view of the components in FIG. 90 in operative relationship with each other;

FIG. 92 is a cross-sectional view of the components taken along line 92-92 of FIG. 91;

FIG. 93 is a view of the components as in FIG. 92 and in operative relationship with a closet collar and mounting portion on a toilet;

FIG. 94 is a perspective view of the components in FIG. 93;

FIG. 95 is an elevation view of the components in FIG. 94;

FIG. 96 is an isolated, elevation view of the cap assembly as in FIGS. 91, 94, and 95;

FIG. 97 is a view of the cap assembly in FIG. 96 from a different perspective;

FIG. 98 is a cross-sectional view of a modified form of cap assembly, according to the present invention, with the shielding parts in an assembled state;

FIG. 99 is a view as in FIG. 93 with one of the shielding parts replaced by a different part and showing additional interchangeable parts making up a kit;

FIG. 100 is a perspective view of the components in FIG. 99;

FIG. 101 is an elevation view of the components in FIG. 100;

FIG. 102 is a view as in FIG. 93 and showing an additional interchangeable shielding part;

FIG. 103 is a perspective view of the components in FIG. 102;

FIG. 104 is an elevation view of the components in FIG. 103;

FIG. 105 is an exploded perspective view of another form of the inventive cap assembly;

FIG. 106 is an elevation view of the cap assembly in FIG. 105 with the shielding parts in an assembled state;

FIG. 107 is a cross-sectional view of the components taken along line 107-107 of FIG. 106;

FIG. 108 is a cross-sectional view of a modified form of cap assembly, according to the invention, in relationship to a cap support assembly as shown in FIG. 3;

FIG. 109 is a bottom view of the components in FIG. 108;

FIG. 110 is an elevation view of a modified form of cap assembly, according to the invention;

FIG. 111 is an exploded view of the shielding parts of the cap assembly in FIG. 110 with the shielding parts in a starting relationship preparatory to connection;

FIG. 112 is a cross-sectional view of the cap assembly taken along line 112-112 of FIG. 110;

FIG. 113 is a bottom view of the cap assembly in FIGS. 110-112;

FIG. 114 is a cross-sectional view of a modified form of one of the shielding parts, as shown schematically in FIG. 86;

FIG. 115 is a perspective view of a further modified form of cap assembly according to the invention;

FIG. 116 is an elevation view of the cap assembly in FIG. 115;

FIG. 117 is a cross-sectional view of the cap assembly taken along line 117-117 of FIG. 116;

FIG. 118 is an exploded perspective view of one form of the inventive cap assembly in relationship to a vessel for containing oils/fragrances;

FIG. 119 is an elevation view of the vessel in FIG. 118 connected to the cap assembly in FIG. 118 and with wicking rods directed thereinto;

FIG. 120 is a cross-sectional view of the components taken along line 120-120 of FIG. 119;

FIG. 121 is a view as in FIG. 120 and showing a modified form of vessel, according to the invention;

FIG. 122 is a fragmentary perspective view of a mounting portion of a toilet with a further modified form of cap assembly, according to the invention;

FIG. 123 is an elevation view of the components in FIG. 122;

FIG. 124 is a cross-sectional view of the components taken along line 124-124 of FIG. 123;

FIG. 125 is a view as in FIG. 122 and showing a further modified form of cap assembly, according to the invention;

FIG. 126 is an elevation view of the components in FIG. 125;

FIG. 127 is a cross-sectional view of the components taken along line 127-127 of FIG. 126;

FIG. 128 is an exploded, fragmentary view showing a shielding part, as in FIG. 86, secured to an anchor bolt on a closet collar to stabilize and align the anchor bolt for direction through a mounting portion on a toilet;

FIG. 129 is an elevation view of the shielding part and closet collar as in FIG. 128; and

FIG. 130 is a cross-sectional view of the components taken along line 130-130 of FIG. 129.

### DETAILED DESCRIPTION OF THE PREFERRED EMBODIMENT

In FIG. 1, a conventional toilet is shown in schematic form at 10. The toilet 10 is designed to be mounted on a support surface 12. For purposes of clarity, the support surface 12 will be considered to be an upwardly facing surface. However, the support surface 12 may actually be formed on a vertical wall, whereby the support surface 12 faces other than upwardly. It should be understood that the references throughout the description and claims herein to “top”, “bottom”, “upwardly facing”, “downwardly facing”, etc., for the support surface 12 and components associated with mounting the toilet 10, are included for reference purposes and should not be limited to literal interpretation. That is, “upward” with respect to a closet collar on a vertical wall is actually sideways/horizontally.

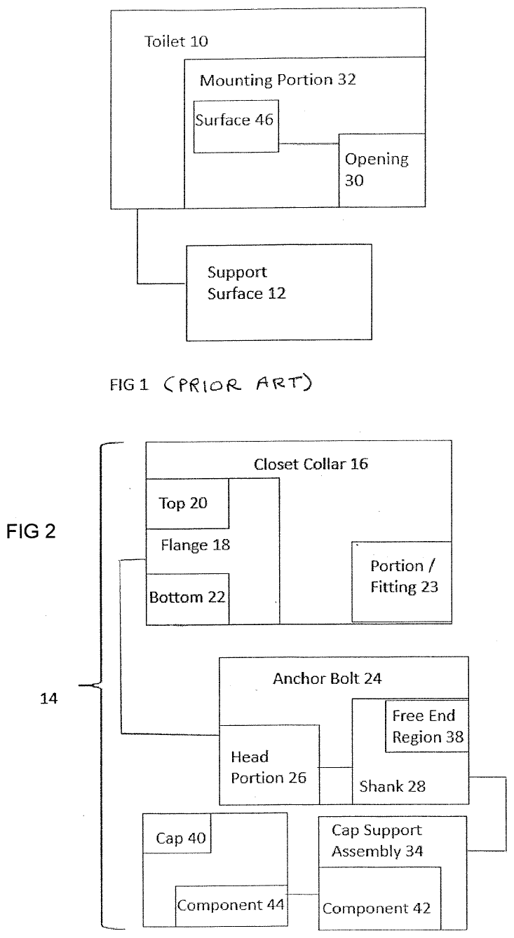

In FIG. 2, there is a schematic depiction of a system at 14, according to the invention, for mounting the toilet 10 to the support surface 12.

The system 14 consists of a closet collar 16 with an associated flange 18 having a top 20 and bottom 22.

The precise configuration of the closet collar 16 is not critical and may take many different constructions, including a portion/fitting 23 that cooperates with the open end of a drain pipe.

The closet collar 16 is anchored with respect to the support surface 12 with the bottom 22 of the flange 18 at floor surface level, or potentially alternatively either above or below floor surface level.

An anchor bolt 24 cooperates with the flange 18 and has a head portion 26 and an elongate shank 28 extending away from the head portion 26 and having a lengthwise axis.

The head portion 26 may be integrally formed with the flange 18 and is more commonly separately formed therefrom and strategically engaged within a slot on the flange 18 so as not to project below the bottom 22 of the flange 18 but to be braced against the flange 18 so as not to be separable by being drawn upwardly away therefrom. The anchor bolt 24 will be considered to be operatively connected to the closet collar 16 in either form.

The anchor bolt 24 and closet collar 16 are configured so that with the anchor bolt 24 operatively connected to the closet collar 16: a) at least a part of the anchor bolt shank 28 projects to above the top 20 of the flange 18 to allow the at least part of the shank 28 to be passed into an opening 30 in a mounting portion 32 of the toilet 10 in FIG. 1; and b) the head portion 26 bears against the flange 18 to prevent the anchor bolt 24 from being drawn axially upwardly and to away from the flange 18.

A cap support assembly 34 is engageable with the anchor bolt shank 28 adjacent a free end region 38 thereon. A cap 40 is provided, with there being cooperating components 42, 44, respectively on the cap support assembly 34 and cap 40, that are engageable to maintain the cap 40 in assembled relationship with the cap support assembly 34. In this assembled relationship, the cap 40 cannot be separated from the cap support assembly 34 by exerting an upward force upon the cap 40 along the lengthwise axis of the elongate shank 28 of the anchor bolt 24.

The cap support assembly 34 and anchor bolt 24 are configured to cooperate so that at least a part of the cap support assembly 34 can be maintained in a plurality of different positions along the lengthwise axis of the anchor bolt shank 28.

In operation, the closet collar 16 is anchored with respect to the support surface 12, with the bottom 22 of the flange 18 at, below, or above the level of the support surface 12. The flange 18 typically has through openings with undercuts to accept heads of anchoring screws so that the anchoring screw heads are nominally flush with the top 20 of the flange 18. With the closet collar 16 anchored and the anchor bolt 24 projecting upwardly from the flange 18, the toilet 10 can be lowered towards the support surface 12, which causes the free end region 38 of the shank 28 to be directed into the opening 30 on the mounting portion 32 of the toilet 10. By engaging a part of the cap support assembly 34 with the free end region 38 of the shank 28, a part of the toilet mounting portion 32 is captively maintained between the part of the cap support assembly 34 and the closet collar flange 18. This is accomplished by causing the part of the cap support assembly 34 to bear against a surface 46 on the mounting portion 32. Multiple anchor bolts 24 are typically used in the same fashion on each toilet 10.

The schematic showing of the components in FIGS. 1 and 2 is intended to encompass not only specific forms of the components as shown herein and described hereinbelow, but an unlimited number of variations of those components and their interaction.

For example, the precise configuration of the toilet mounting portion 32 is not critical to the present invention. Further, the closet collar 16 may have many different forms that include the flange 18, with the flange potentially being one or more parts—in the latter case potentially including a repair flange part used in conjunction with the original flange 18. Sealing components—with or without mounting ears-between flange parts and between a flange part and a subjacent support surface may be considered to be part of the flange. For simplicity, the stacked flange parts are considered to make up a single flange.

Similarly, certain aspects of the invention can be practiced with the anchor bolt 24 fixedly attached to the flange 18, whereas in specific embodiments herein the anchor bolt 24 is initially separate from and attached to the flange 18.

The cap 40 is generally desired to perform a protective covering function and additionally to improve the overall aesthetics of the mounted toilet at the location of the various mounting portions 32. Its exposed surface shape is not in any way limited.

The cap support assembly 34 can also take a multitude of different forms, with those specific forms depicted and described herein being exemplary in nature only.

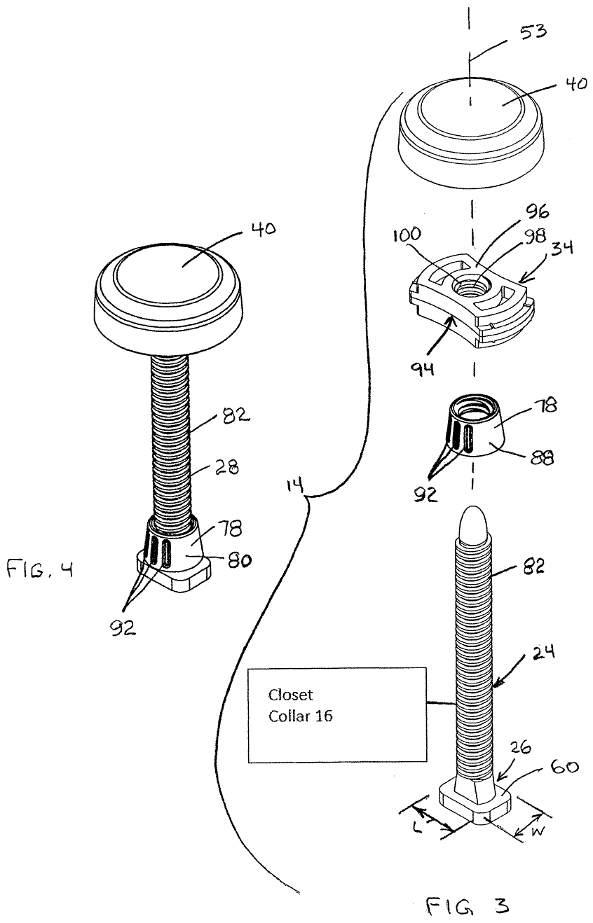

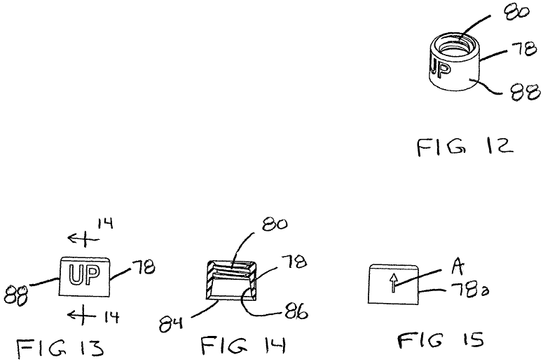

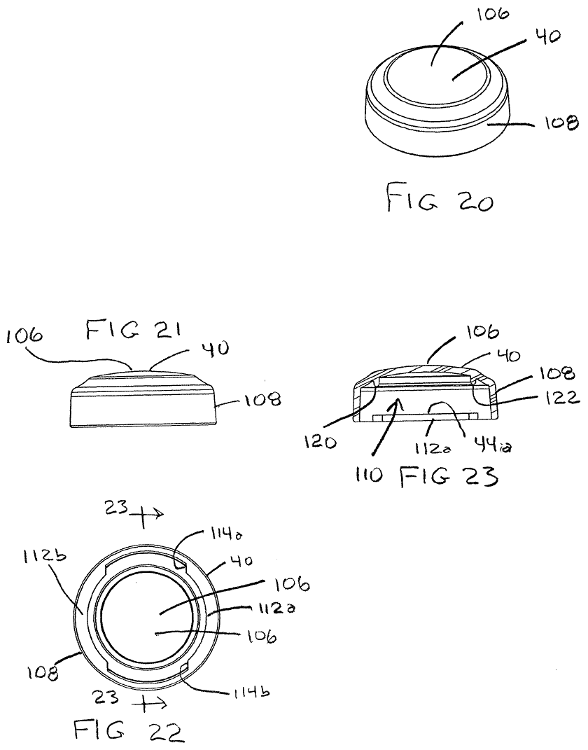

One exemplary form of the system 14 is shown in FIGS. 3-23, in association with the toilet 10, as shown in FIG. 1.

In this embodiment, the anchor bolt 24 is separate from the closet collar 16, including the flange 18 making up a part of the closet collar 16. The closet collar 16 has a cylindrical body portion/fitting 23, formed integrally with the flange 18, that aligns with a drain pipe 50 and cooperates therewith in well-known fashion to define a communication path between the toilet bowl and the drain pipe 50.

The toilet 10 has multiple mounting portions 32, each which can cooperate with the anchor bolt 24 in like fashion. The toilet 10 is configured to be anchored to the support surface 12 and to be fixedly mounted with respect thereto through the system 14.

The head portion 26 and elongate shank 28 extending away from the head portion 26 cooperatively define what is commonly identified as “T bolt”. The depicted head portion configuration has a generally rectangular shape as viewed along the lengthwise axis 53 of the elongate shank 28 including a length dimension L and a width dimension W. This footprint is designed to engage the flange 18 through introduction into a key slot 54 as shown in FIG. 5. The slot 54, as viewed from above, has a substantially rectangular entry opening 56 slightly larger peripherally than the footprint of the head portion 26 and that is contiguous with a narrower arcuate slot portion 58 with a radius matched generally to that of the flange 18, which is typically ring-shaped. By lowering the head portion 26 into and through the entry opening 56, the narrower shank 28 can be shifted guidingly through the arcuate slot portion 58 which places an axially facing surface 60 on the head portion in confronting relationship with spaced, downwardly facing surface portions 62 on opposite edges of the slot 56. This relationship can be seen clearly in FIG. 6, wherein a free end surface 64 on the head portion 26, facing axially oppositely to the surface 60, is shown in confronting relationship with the support surface 12.

Thus, the anchor bolt 24 can be operatively connected to the closet collar 16 by lowering the head portion 26 into the entry opening 56 and guidingly translating the anchor bolt 24 in a slightly arcuate path, as indicated by the arrow 66 in FIG. 5. With the anchor bolt 24 operatively connected, an upward force on the anchor bolt shank 28 brings the surface 60 into engagement with the surface portions 62 to prevent the anchor bolt 24 from being drawn upwardly away from the flange 18.

As noted above, the precise structure for operatively connecting the anchor bolt to the closet collar is not critical, with the depicted form being exemplary in nature only.

In a preferred form, the anchor bolt 24 is made from a non-metal material. In the depicted embodiment, the shank 28 has an outer surface 68 with a diameter D. The head portion 26 includes a transition region at 70, between a proximal end 72 of the shank 28 and the surface 60, that is progressively radially enlarged towards the surface 60 that is defined on a squared head piece 73 bounded by the axially oppositely facing surfaces 60, 64. The transition region has radially oppositely facing flat surfaces 74 that are spaced a distance approximately equal to the diameter D to allow the transition region 70 to move through the arcuate slot portion 58.

With an upward axial tensile force applied to the shank 28, the transition region 70 distributes this force over a larger area of the head piece 73 than the cross-sectional area of the shank above the transition region 70.

A stabilizing component 78 has internal threads 80 that engage external threads 82 on the shank 28 to allow the stabilizing component 78 to be turned and advanced along the length of the shank to the FIG. 3 position, wherein the reduced thickness t of the flange 18 at the key slot 54, between the surface portions 62 and the top 20 of the flange 18, is captured between a bottom edge 84 of the stabilizing component 78 and the surface 60 on the head portion 26. The head piece 73 is typically keyed to the flange 18 so that the anchor bolt 24 will not turn around its axis 53 as the stabilizing component 78 is threadably connected thereto and tightened.

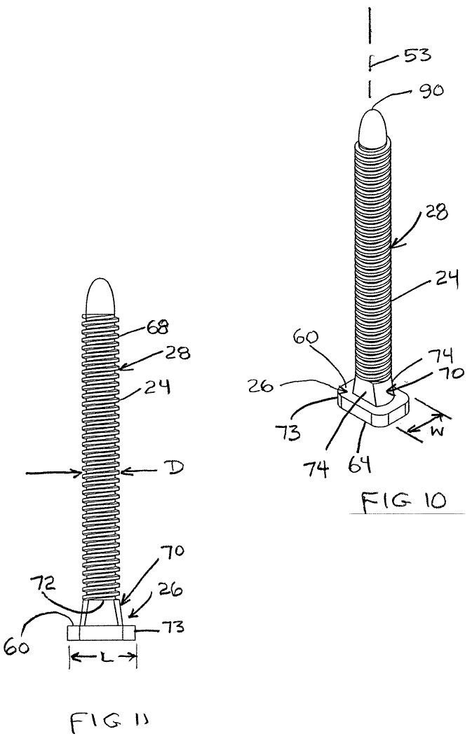

As seen in FIG. 12, the internal threads 80 extend over only a portion of the axial extent of the stabilizing component 78. The lower region of the stabilizing component 78 has a bore portion 86 that increases in diameter in a downward direction from the threads 80 to allow the lower region of the stabilizing component 78 to surround part or all of the transition region 70 thereby to effect reinforcement of the transition region 70 and stabilizing of the connection of the anchor bolt 24 and flange 18.

To avoid improper inverted orientation of the stabilizing component 78, as it is being threadably engaged to the shank 28, visible indicia are provided on the outer surface 88 thereof. In FIGS. 10 and 11, the word “UP” is provided, whereas in FIG. 13 an upwardly pointing arrow A is provided on a modified form of the stabilizing component 78a to assist proper orientation.

To facilitate alignment and joining of components, including but not limited to the stabilizing component 78, and a part of the cap support assembly 34, as described below, the distal end 90 of the shank 28 has a rounded configuration with a progressively increasing diameter from top to bottom.

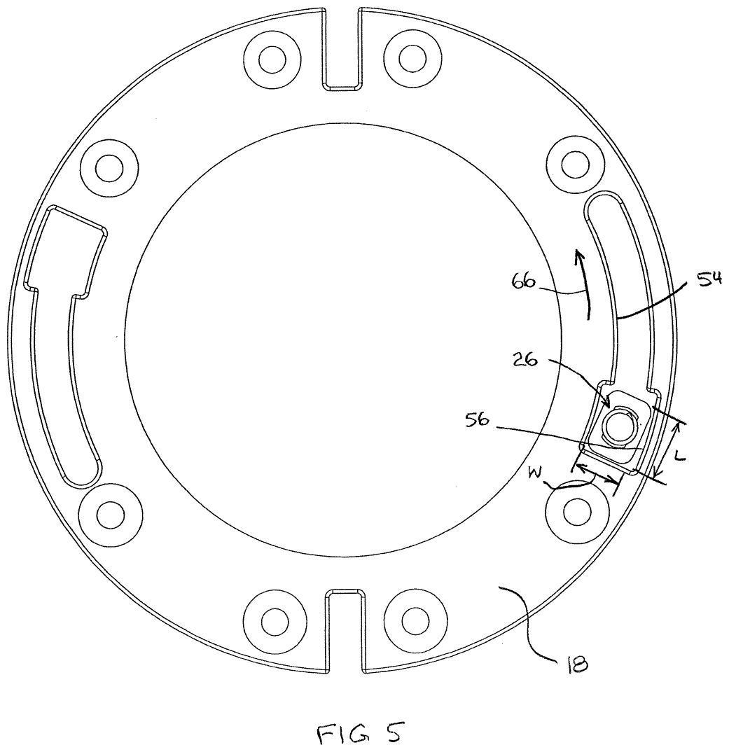

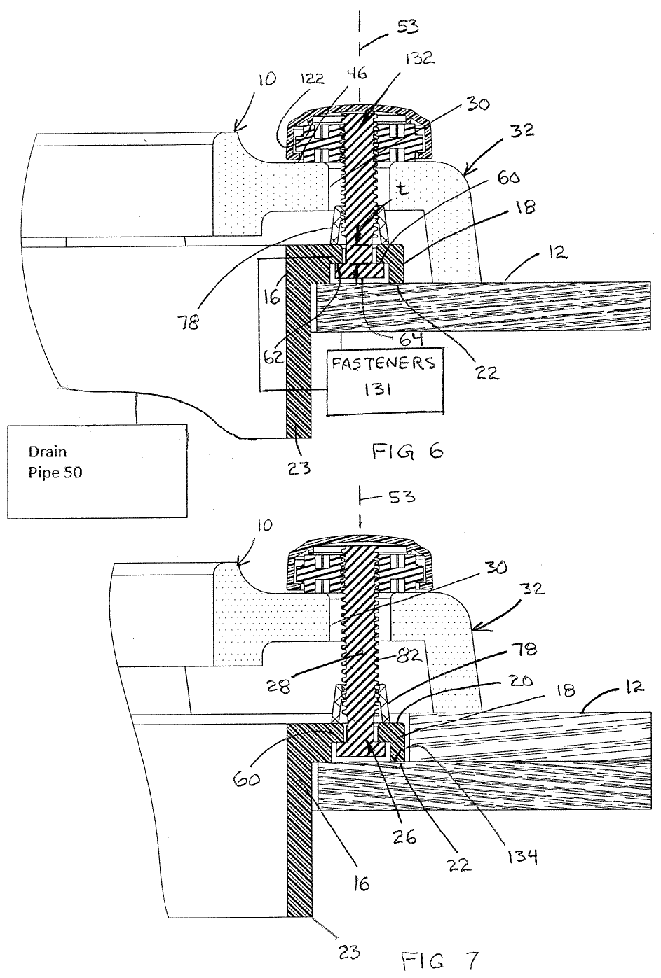

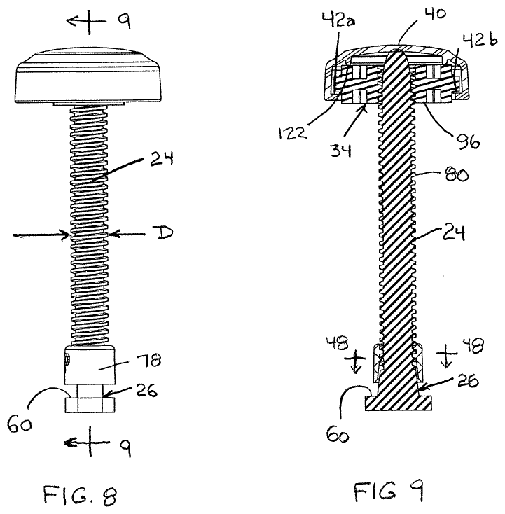

To assist hand-tightening of the stabilizing component 78, the outer surface 88 is provided with discrete, radial projections 92 (FIGS. 3 and 4). This knurled arrangement facilitates gripping, which is desirable given the potentially small gripping diameter of the stabilizing component 78.

The cap support assembly 34 consists of a nut assembly 94. The cap support assembly 34 nut assembly 94 may be made from multiple parts/components, with the depicted form again only exemplary in nature. While not limited to this construction, the nut assembly 94 has a body 96 with a through bore 98 having internal threads 100 that are engageable with the external threads 82 on the anchor bolt 24.

The nut assembly 94 is symmetrical about a plane P (FIG. 19), orthogonal to the axis 53 of the through bore 98, which allows the nut assembly 94 to be threadably engaged with the body 96 in the FIG. 3 orientation or inverted from that orientation. This simplifies assembly in that it obviates the need for the installer to identify a top and a bottom of the body 96.

For purposes of simplicity, the cap 40, body 96, stabilizing component 78, and anchor bolt shank 28 will be described herein to have the same axis 53. However, it is not necessary that the cap 40, body 96, stabilizing component 78, and shank 28 all have the same axis.

In one exemplary form, and without limitation, each of the cooperating components 42, 44 is in the form of at least one surface/edge. With the cap 40 in assembled relationship with the cap support assembly 34, the at least one surface/edge 42 on the cap support assembly 34 confronts the at least one surface/edge 44 on the cap 40 to block movement of the cap 40 axially away from the cap support assembly 40.

The body 96 on the nut assembly 94 has at least one radially projecting portion 102a and, as depicted, two radially oppositely projecting portions 102a, 102b, on each of which at least one of the surface/edges 42 is defined.

Each radially projecting portion 102a, 102b has a radially outer edge 104a, 104b, respectively, each extending less than 90° around the body axis 53.

Since the body 96 cooperates with the shank 28 and cap 40 in the same manner in inverted orientations, it is only necessary to describe one of the body halves above or below the plane P in FIG. 19.

The cap 40 has a top wall 106 and a peripheral wall 108 cooperatively producing an inverted cup-shaped configuration. The cap 40 defines a receptacle 110 with a volume. With the cap 40 in assembled relationship with the cap support assembly 34, as shown in FIGS. 6-9, at least part of the cap support assembly 34 is extended into the volume of the receptacle 110.

The cap 40 has arcuate rim portions 112a, 112b extending radially inwardly from the peripheral wall 108. As depicted, the rim portions 112a, 112b are substantially the same in configuration, although this is not a requirement.

Circumferential gaps 114a, 114b are defined between the rim portions 112a, 112b at diametrically opposite locations.

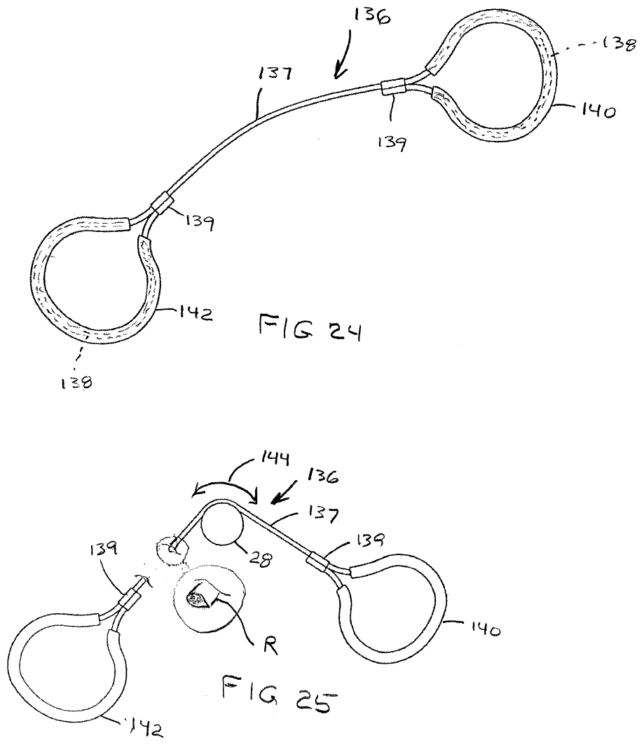

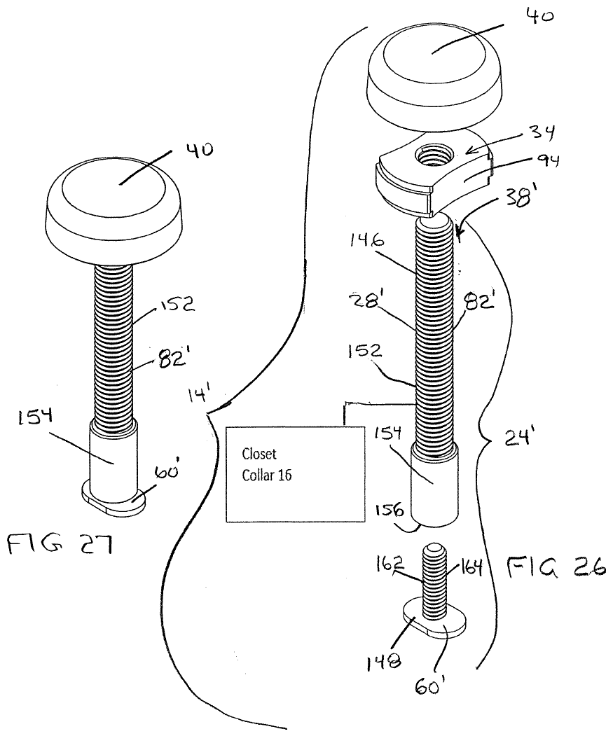

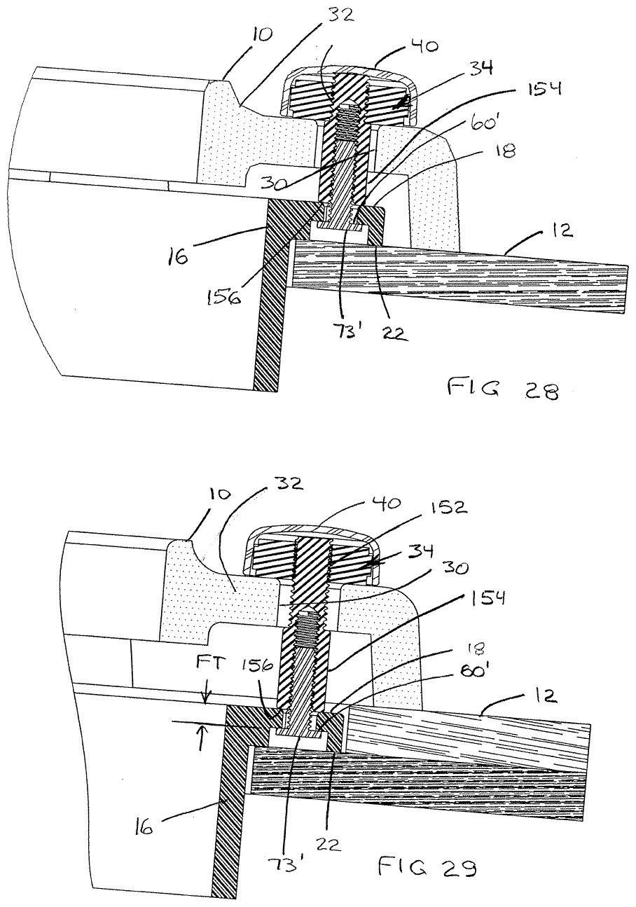

Each of the arcuate rim portions 112a, 112b defines a surface/edge 44a, 44b, respectively, of like construction. In FIG. 23, the surface/edge 44a is shown on the arcuate rim portions 112a and faces axially upwardly.

The radially projecting portions 102a, 102b have arcuate ribs 116a, 116b axially centered on the body 96 and having a vertical/axial dimension AD (FIG. 19) less than the full axial dimension AD1 (FIG. 18) of the body 96. As depicted, the dimension AD is approximately one-third the dimension AD1. This dimensional relationship is not critical. This produces steps 118a, 118b, resulting in the formation of the surface/edge 42a, 42b on each radially projecting part 102a, 102b. As explained above, a mirror image of this shape is defined on the axially opposite side of the body 96.

The cap 40 and body 96 are configured so that with the body 96 and cap 40 in axial alignment and spaced axially from each other, the radially projecting portions 102a, 102b can be angularly aligned, one each, with the gaps 114a, 114b. This represents a pre-assembly angular orientation between the cap 40 and cap support assembly 34. By then moving the cap 40 and nut assembly 94 axially towards each other, the axially facing surfaces/edges 42a, 42b on the cap support assembly 34 can move axially up to and past the surfaces/edges 44a, 44b on the cap 40.

By then relatively turning the cap 40 and body 96 around the axis 29, the surfaces/edges 44a, 44b can be placed in confronting relationship with the surfaces/edges 42a, 42b, whereupon the cap 40 cannot be separated from the cap support assembly 34 by exerting an upward force upon the cap 40 along the axis 53.

Corresponding surfaces/edges 44a′, 44b′ are used in the same fashion with the body 96 inverted.

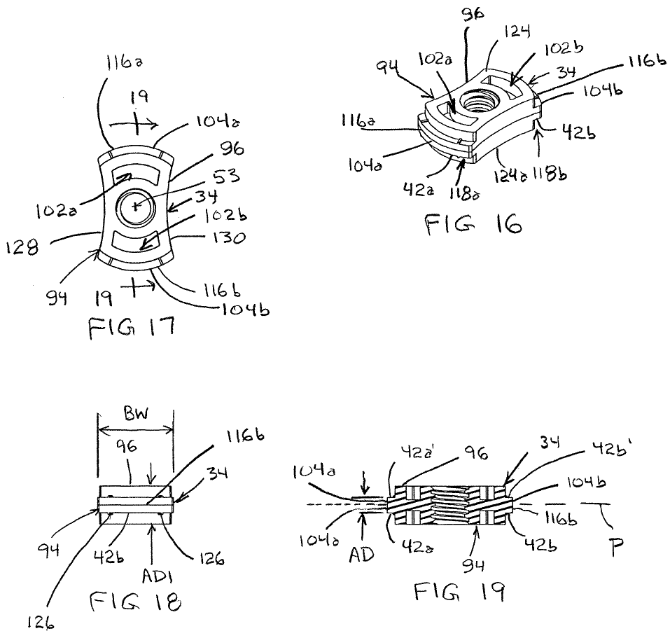

An annular rim 120, that may be continuous or made up of arcuate parts, depends from the top wall 106 of the cap 40 and defines a downwardly facing guide surface/edge 122. The guide surface/edge 122 acts against the upper surface 124 of the body 96 when in the FIG. 16 orientation. This controlled contact area facilitates smooth guidance of the cap 40 relative to the body 96. The degree of radial spacing of the guide surface/edge 122 from the peripheral wall 108 dictates the degree of surface contact and frictional resistance between the cap 40 and body 96. The surface 124 is smooth to facilitate sliding of the guide surface/edge 122 thereagainst.

To generate a desired holding force between the cap 40 and cap support assembly 34, with the cap 40 in fully assembled relationship therewith, one or more of the surfaces/edges may incorporate a detent part. In FIG. 18 two exemplary detent parts 126 are shown on the surface/edge 42b which confronts a surface/edge 44b on the cap 40 with the cap 40 in assembled relationship with the cap support assembly 34. For purposes of simplicity, the detent parts 126 are considered to be part of the surface/edge 42b on which they are provided. This is true of all the detent parts used throughout the system 14 on confronting surfaces/edges. The detent arrangement may be used to enhance a holding force between the cap 40 and body 96 or to reduce the contact area between confronting surfaces/edges, which may facilitate smooth relative turning between the cap 40 and cap support assembly 34.

The detent arrangement dictates the resistance to the cap 40 in turning relative to the cap support assembly 34 once the cap 40 is placed in assembled relationship with the cap support assembly 34 and may alternatively be configured to consistently maintain the assembled cap 40 in a predetermined angular relationship with the cap support assembly 34.

As seen in FIG. 9, the body 96 becomes effectively captured between the guide edge 122 and the surfaces/edges 44a, 44b with the cap 40 in assembled relationship.

To facilitate grasping and turning of the body 96, the body 96 is formed with radially oppositely opening concave surfaces 128, 130. The body width between the surfaces 128, 130 is adequate that the installer can comfortably exert a substantial torque upon the body 96 during the assembly process. The axial dimension of the body 96 is selected to be graspable positively to effect adequate tightening. A thickness in the range of ⅜ to ¾ inch is appropriate, however, this range should not be viewed to be in any way limiting.

In a typical installation, with reference to FIG. 6, the closet collar 16 is fixed with respect to the surface 12 using conventional fasteners 131, such as screws, etc. Each anchor bolt 24 is directed into a key slot 54 strategically situated below a through opening 30 on the mounting portion 32 of the toilet 10 and stabilized using the stabilizing component 78.

The toilet 10 is then aligned and lowered towards the support surface 12, whereupon the anchor bolt shanks 28 project through toilet openings 30 to above the surfaces 46 on the mounting portions 32.

The body 96 on the nut assembly 94 is then threadably engaged at the free end region 132 of the shank 28 projecting to above the surface 46 on the mounting portion 32 and thereafter hand-tightened suitably so that the mounting portion 32 is stabilized and any seals (not shown) are properly seated. The torque is preferably applied entirely by the user's hand, which is adequate to complete the mounting process with the mounting portions 32 captured relative to the support surface 12. The smooth surfaces 124, 124a slide readily against the surface 46 or a washer (not shown) thereon to allow hand tightening of the body 96 to be adequate to effectively complete the mounting process.

Thereafter, the cap 40 is placed in the pre-assembly relationship with the body 96 and lowered until the edge 122 on the cap 40 abuts to the body 96. The cap 40 is then turned through approximately 90° to place the cap 40 in fully assembled relationship with the cap support assembly 34.

As noted previously, different lengths of the anchor bolt 24 may be required based upon the configuration of the toilet mounting portion 32 and the relationship between the top 20 of the closet collar flange 18 and the support surface 12. For example, in FIG. 6, the bottom 22 of the closet collar flange 18 is supported directly against the upper floor/support surface 12, whereas in FIG. 7, the bottom 22 of the closet collar flange 18 is supported by an offset surface 134 spaced below the support surface 12. As a result, a longer anchor bolt 24 is required in the FIG. 7 installation than that in FIG. 6.

One option is to provide anchor bolts 24 of different length but, as noted above, even doing so still may require cutting to effect shortening thereof to accommodate a cap.

As noted above, in one preferred form, the anchor bolt shank 28 is made from a non-metal material. As shown in FIGS. 24 and 25, a cutting tool 136 may be provided with an elongate flexible cutting element 137 doubled back on itself to form spaced gripping elements/loops 138. The loops 138 are maintained using crimped pieces 139. Soft, flexible tubes 140, 142 surround the gripping elements/loops 138 to facilitate comfortable gripping. The spaced gripping elements/loops 138 that can be held, one each in opposite hands, to allow the flexible cutting element 137 to be drawn back and forth against the anchor bolt shank 28, as indicated by the double-headed arrow 144. This action progressively abrades the non-metal material to eventually sever the shank 28 and thereby separate a discrete length thereof to redefine the free end region 132 at which the body 96 is threadably connected.

The flexible element 138 can be readily wrapped around the shank 28 in a “U” shape whereupon manipulation of the elongate flexible element 138 through the gripping elements 140, 142 can occur in a space distanced adequately from the toilet 10 that the cutting operation can be conveniently carried out without interference from the toilet 10.

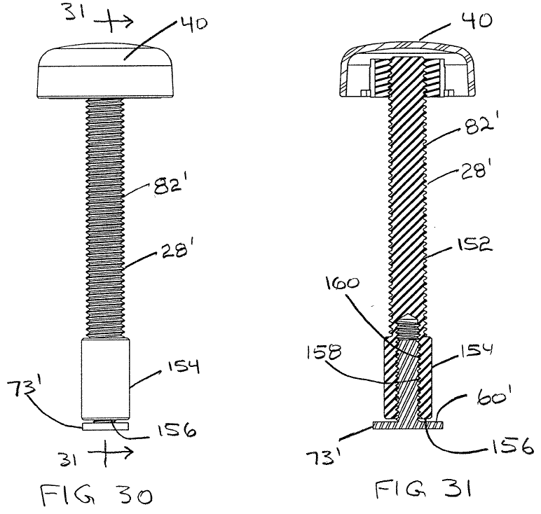

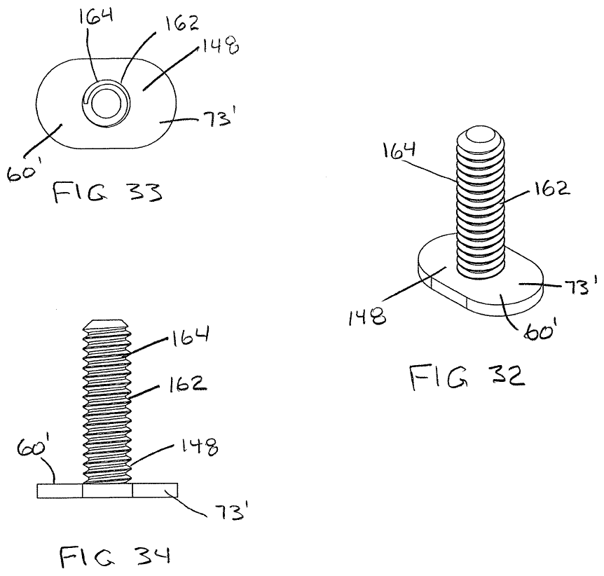

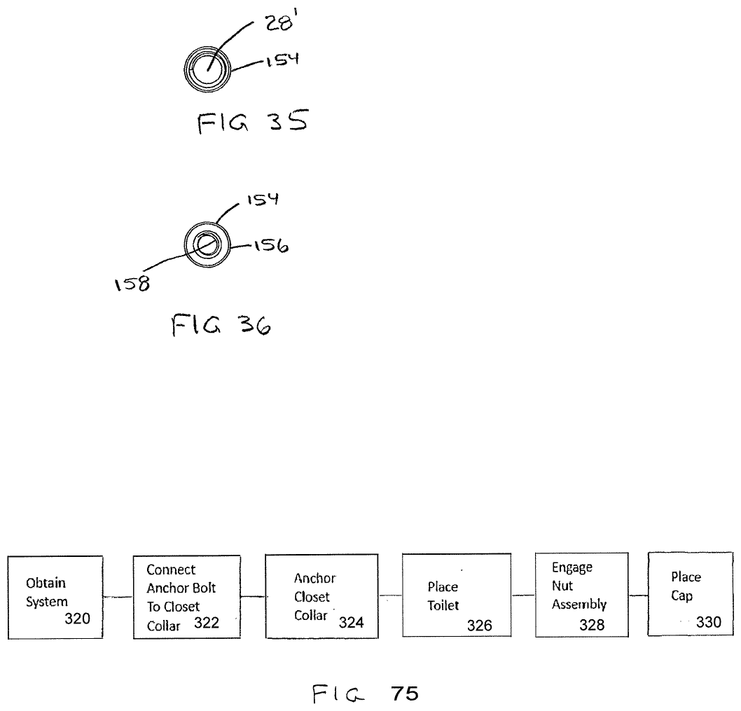

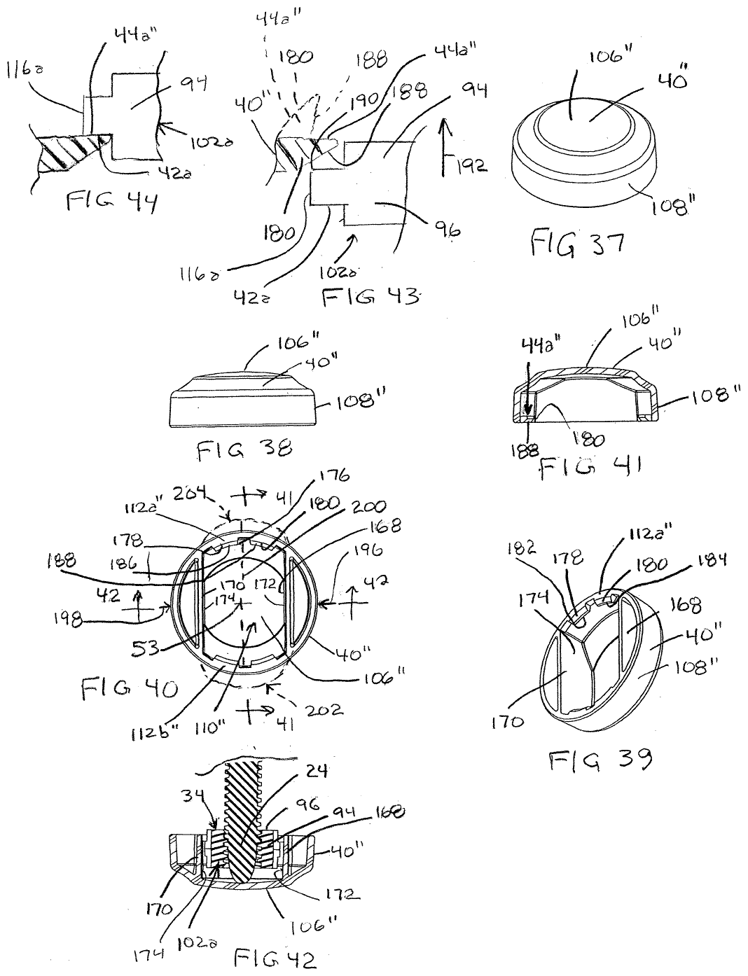

In FIGS. 27-36, a modified form of the system 14 is shown at 14′.

The system 14′ differs from the system 14 primarily by reason of a different configuration of the anchor bolt 24′. All other components in the system 14′ can be the same as those shown in the system 14.

The anchor bolt 244′ consists of first and second joinable parts 146, 148. The first joinable part 146 defines an elongate shank 28′ with external threads 82′ to threadably engage the nut assembly 94 making up the cap support assembly 34, as in the system 14.

The second joinable part 148 defines a head piece 73′ corresponding to the head piece 73 on the anchor bolt 28.

The first joinable part 146 has a stepped outer diameter with a smaller diameter length portion at 152 and a larger diameter length portion 154.

The smaller diameter length portion 152 is threaded to engage the nut assembly 94 that is part of the cap support assembly 34. The smaller diameter length portion 154 terminates in a proximal annular surface/edge 156 that faces axially downwardly.

A blind bore 158 is formed from the surface/edge 156 through the larger diameter length portion 154 and a short distance into the smaller diameter length portion 152. The bore 158 has internal threads 160 that engage external threads 162 on a post 164 fixed with respect to the head piece 73′ and projecting axially upwardly therefrom.

With the second joinable part 148 threadably engaged with the first joinable part 146, a flat, axially facing surface 60′, corresponding to the surface 60 on the anchor bolt 24, faces the surface/edge 156 defined by the larger diameter length portion 154.

With the first and second joinable parts 146, 148 threadably engaged with each other, the resulting anchor bolt 24′ has essentially the same “T bolt” configuration as the anchor bolt 24 and functions in substantially the same manner in terms of being connected to the closet collar 16. The primary difference is that the larger diameter length 154, and the surface/edge 156 thereon, perform the stabilizing function of the separate, dedicated stabilizing component 78 in the system 14.

As seen in FIGS. 28 and 29, corresponding respectively to FIGS. 6 and 7, the anchor bolt 24′ is stabilized by causing the flange 18 on the closet collar 16 to be captured between the head surface 60′ and the surface/edge 156.

The anchor bolt 24′ can be engaged with the closet collar flange 18 by initially engaging the first and second joinable parts 146, 148 in a manner that the spacing between the surface 60′ and surface/edge 156 is slightly greater than the flange thickness FT (FIG. 29). This allows the head piece 73′ to be directed into the key slot 54 and translated therealong, after which the first joinable part 146 can be turned to eventually tightly capture the closet collar flange 18 between the surface 60′ and surface/edge 156.

In a preferred form, the first joinable part 146 is made at least partially from a non-metal material and the second joinable part 148 is made from a metal material. The metal material of the second joinable part 148 strengthens the same against failure with the nut assembly 94 tightened and a substantial tensile force being exerted upon the post 164.

While no specific, critical material limitations are intended, the metal/non-metal combination facilitates severance of the free end region 38′ of the elongate shank 28′, as described above. The larger diameter length portion 154 accommodates the threaded post 164 and has a large enough diameter that it is not significantly weakened by the bore 158.

As noted above, FIGS. 28 and 29 show the bottom 22 of the closet collar flange 18 mounted at the level of the support surface 12 and below the support surface 12, corresponding to the site conditions in FIGS. 6 and 7, respectively.

As noted, the cap support assembly 34 and cap 40 are connected to each other and the anchor bolt 24′ in the same manner that these same components are connected to the anchor bolt 24.

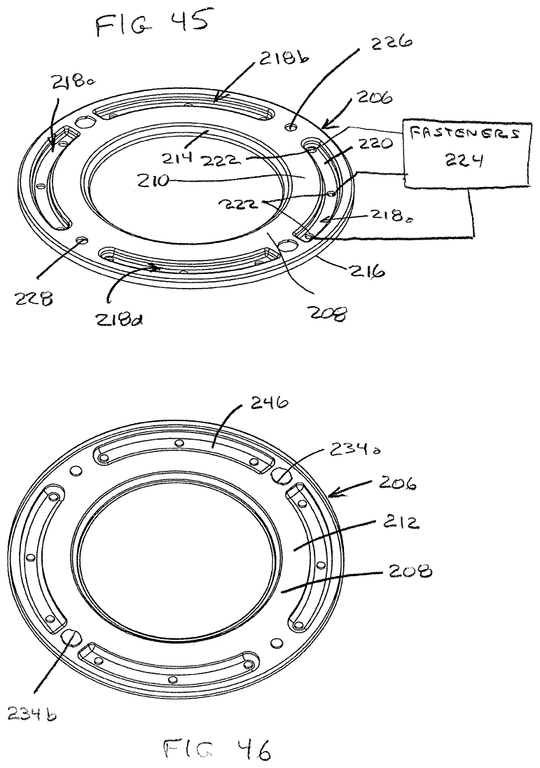

In FIGS. 37-44, a modified form of cap is shown at 40″, usable with either form of the anchor bolt 24, 24′, or another form thereof, in combination with the nut assembly 94.

The cap 40″ is configured to be snap fit into assembled relationship with the cap support assembly 34.

The cap 40″ has a top wall 106″ and a peripheral wall 108″ cooperatively producing an inverted cup-shaped configuration.

Arcuate rim portions 112a″, 112b″ extend radially inwardly from the peripheral wall 108″. The rim portions 112a″, 112b″ have the same configuration. Dividing walls 168, 170 span spaced portions of the peripheral wall 108″ and respectively have substantially flat surfaces 172, 174 which are substantially parallel to each other and bound a receptacle 110″ within the volume bounded cooperatively by the cap 40″ and peripheral wall 108″.

The surfaces 172, 174 are spaced a distance slightly greater than the width of the body 96 on the nut assembly 94, which is identified by the dimension BW in FIG. 18. This allows the nut assembly 94 to be axially aligned with the cap 40″ and directed into the receptacle 110″ without significant, or any, interference between the body 96 and the surfaces 172, 174.

The diametrically opposite rim portions 112a″, 112b″ are mirror images of each other. The exemplary rim portion 112a″ has a circumferential gap/interruption 176 formed therein, thereby producing separate tab portions 178, 180 which can be independently flexed/bent.

The tab portions 178, 180 have surface/edge portions 182, 184, respectively, that cooperatively define a surface/edge 44a″ corresponding to the surface/edge 44a on the cap 40.

The rim portions 112a″, 112b″ are dimensioned and configured so that they each cooperate with one of the radially projecting portions 102a, 102b of the nut assembly 94 in like fashion. Thus, explanation of this interaction will be limited to the exemplary cooperating radially projecting portion 102a and the arcuate rim portion 112a″.

With the nut assembly 94 and cap 40″ in axially aligned relationship and initially spaced from each other, the nut assembly body 96 can be advanced into the receptacle 110″. As this occurs, a corner 190 on the arcuate rib 116a engages inclined surface portions 186, 188 on the tab portions 178, 180. Continued axial movement in the direction of the arrow 192 in FIG. 39 produces a camming action between the corner 190 and the inclined surface portions 186, 188 to thereby progressively flex/bend the tab portions 178, 180, in a manner as shown for the exemplary tab portion 180 in FIG. 39, from the solid line position therein to the dotted line position. This allows the surface/edge 42a on the nut assembly 94 to move axially up to and beyond the surface/edge 44a″ on the cap 40″. Once the surface/edge 42a moves axially beyond the surface/edge 44a″, the tab portions 178, 180, under residual forces generated therein, bend back and assume their original, undeformed states, which places the surfaces/edges 42a, 44a″ in confronting relationship.

The radially projecting portion 102b cooperates with the rim portion 112b″ in like fashion.

Accordingly, the cap 40″ can be axially aligned with the nut assembly 94 and snap fit into place. The wall surfaces 172, 174 cooperate with the nut assembly body 96 to key the nut assembly body 96 and cap 40″ against relative angular movement around the shared axis 53.

Aside from defining a receptacle shape complementary to the nut assembly body 96, the walls 168, 170 also distribute squeezing forces, applied at diametrically opposite locations as indicated by the arrows 196, 198, so as to cause the cap 40″ to assume a more oval shape with a major axis 200 spanning the arcuate rim portions 112a″, 112b″. Effectively, the cap 40″ bulges at diametrically opposite regions 202, 204, thereby shifting the arcuate rim portions 112a″, 112b″ away from each other adequately that the nut assembly body 96 can be drawn axially away from the cap 40″ without interference between the previously confronting surfaces/edges—as with exemplary surfaces/edges 44a″ on the cap 40″ and surface/edge 42a on the cap support assembly 34.

As explained in the Background section herein, closet collars are commonly compromised either over time, during the assembly process, or during a repair procedure, as when a toilet is re-mounted. As an alternative to replacing the closet collar, it is known to use a repair flange that becomes integrated into the existing closet collar.

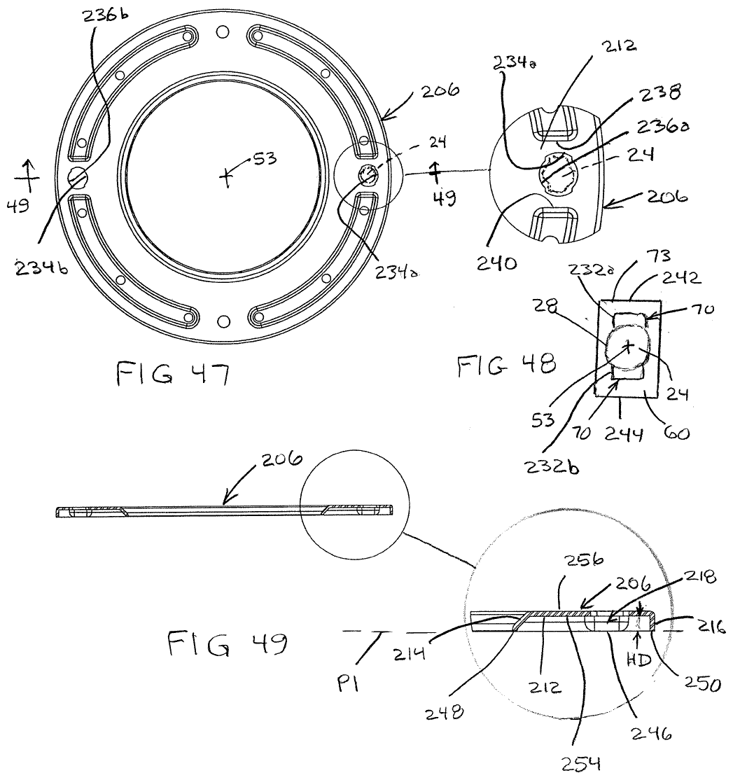

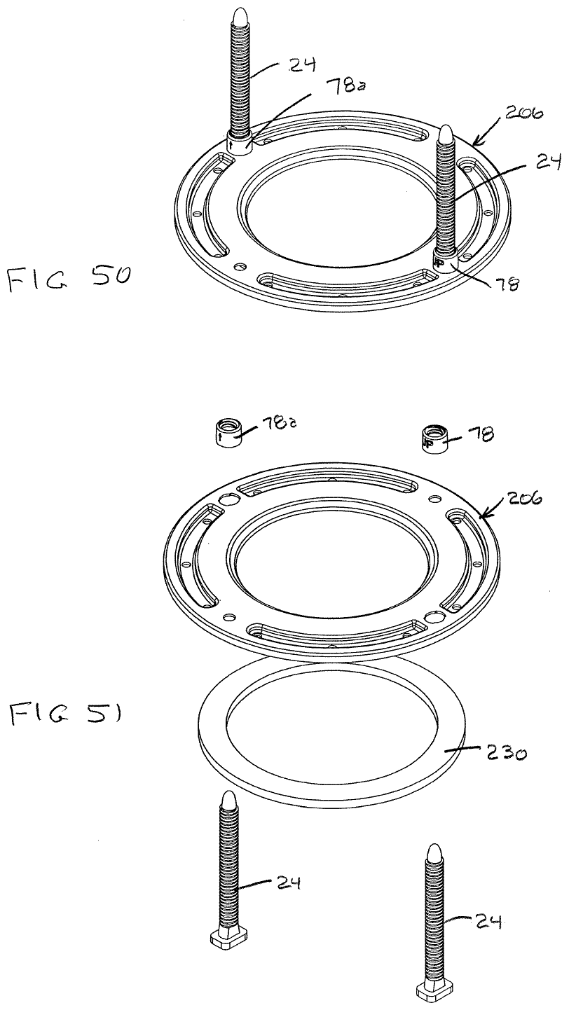

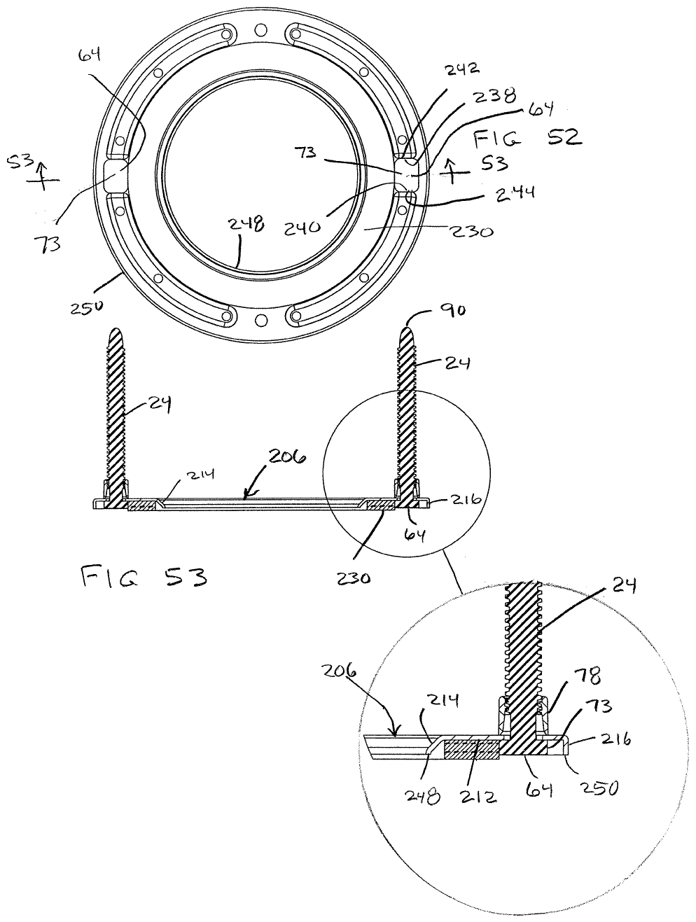

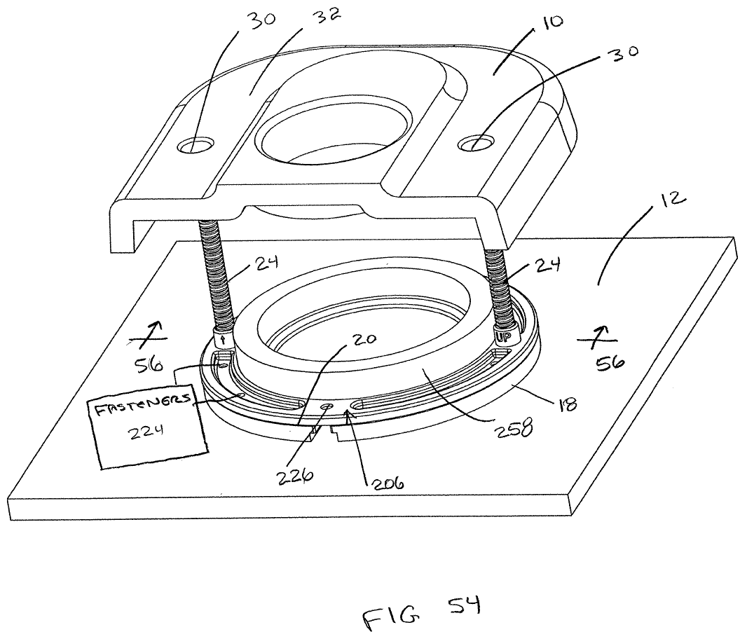

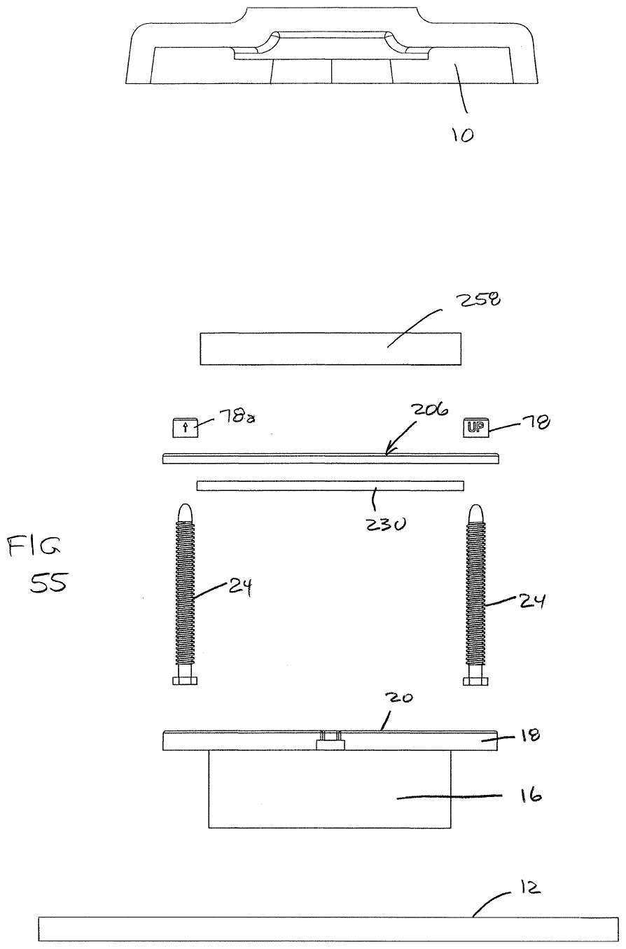

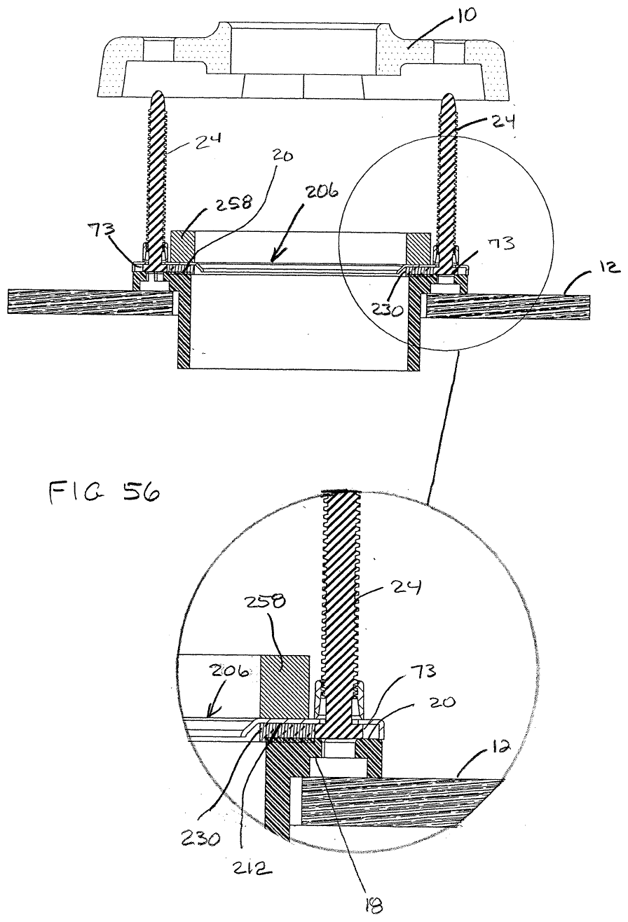

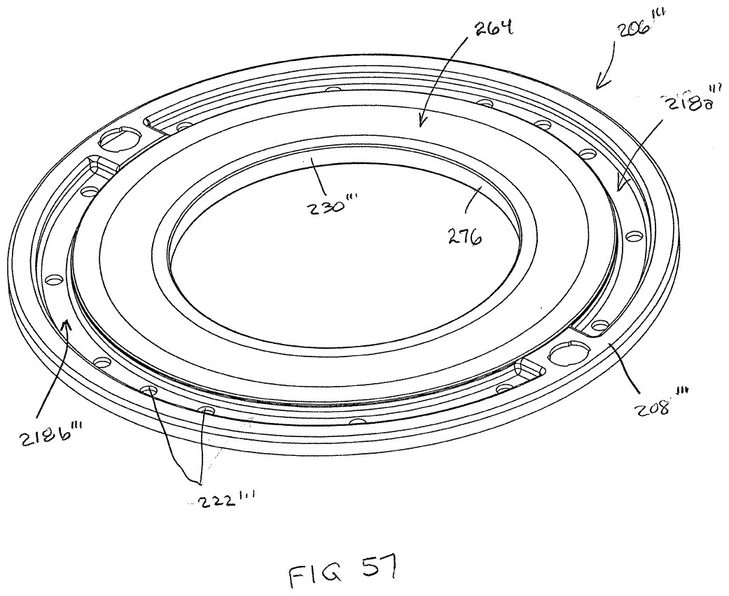

An exemplary form of repair flange, according to the invention, is shown at 206 in FIGS. 45-53. The depicted repair flange 206 has a ring-shaped body 208 with a top surface 210 and a bottom surface 212.

The body 208 has an annular depending edge 214 defining the inside ring dimension and an outer depending edge 216. The inclusion of the edges 214, 216 rigidifies the body 208 to maintain the shape thereof.

The body 208 can be made from a metal or a non-metal material. In a preferred form, the body 208 is made from one of stainless steel, cold-rolled steel, etc., and may have a protective coating, such as an e-coating. Other coating or types of coatings may be utilized to prevent rust and maintain appearance.

The body 208 has a plurality of arcuate undercuts 218a, 218b, 218c, 281d circumferentially spaced around the body axis 53. The undercuts 218 further rigidify the body 208.

Each of the undercuts 218 is shown to have a similar construction, which is not a requirement. The exemplary undercut 218a has a bottom wall portion 220 with openings 222 therethrough, each to accept a fastener 224, as in the form of a screw, extendable through the opening 222 and into the support surface 12. The undercut arrangement allows the heads of the fasteners 224 to be flush, or near flush, with the top surface 210 on the body 208.

The openings 222, and additional openings 226, 228 are provided through the body 208 to allow the fasteners 224 to be directed through the body 208 either directly into the surface 12, or through an intermediate existing closet collar flange 18, as shown in FIG. 52. The openings 222, 226, 228 can be strategically placed to align with existing openings in the already present flange 18, whereby fasteners used to fix the flange 18 can be removed and replaced by fasteners that extend through aligned openings through the repair flange body 208 and flange 18.

To seal between the bottom surface 212 of the body 208 and the top 20 of the existing flange 18, a ring-shaped sealing component 230 is provided. The sealing component 230 may take many different forms. As one example, the sealing component 230 may be a foam gasket.

While the sealing component 230 may be provided to a purchaser separately from the repair flange body 208, in one form, the sealing component 230 is adhered to the bottom surface 212 of the body 208. This avoids a situation where a consumer might inadvertently omit any type of sealing component, whereby an escape path for sewer gases is present between the repair flange 206 and the existing flange 18. The use of a foam gasket material potentially provides for an airtight seal between the repair flange 206 and the existing flange 18.

Exemplary forms of flexible material suitable for the construction of the sealing component 230 are EVA, TPR, TPE, TPU, PVC, SBR, EPDM, neoprene, rubber, glue, wax, gel, or foam material like EVA, neoprene, silicone, PVC, PE foam, PU foam, or other open or closed cell foams known in the art or devisable by one skilled in the art.

The depicted repair flange 206 is constructed to be adapted to the anchor bolts 24, as described in prior embodiments.

FIG. 48 shows a cross-sectional view of the anchor bolt 24 as shown in FIG. 9. As viewed from the distal end of the anchor bolt 24, the threaded elongate shank 28 has a circular shape. The transition region produces diametrically opposite rectangular shapes 232a, 232b projecting diametrically oppositely from the axis 53 of the shank 28. The head piece 73 has a larger, rectangular, perimeter shape, as viewed from the FIG. 48 perspective.

To accommodate the anchor bolts 24, the repair flange body 208 has diametrically opposite through openings 234a, 234b, each to accommodate one of the anchor bolts 24. Each of the through openings 234 has a shape at least nominally matched to the cross-sectional shape of the shank 28 and rectangular shapes 232a, 232b, as seen in FIG. 48. As a result, the elongate shank 28 can pass freely through the openings 234a, 234b, whereupon the transition region 70 keys against the edges 236a, 236b bounding the openings 234a, 234b, respectively. As the keyed engagement between the transition region 70 and edges 236a, 236b takes place, the surface 60 on the head piece 73 abuts to the bottom surface 212 of the repair flange body 208.

At the same time, circumferentially facing surfaces/edges 238, 240 defined by adjacent arcuate undercuts 218 at the bottom of the body 208, confront spaced surfaces/edges 242, 244, respectively, on the head piece 73 to thereby effect further keying that stabilizes the anchor bolt 24 against turning within the openings 234a, 234b and relative to the body 208. The stabilizing component 78 can be engaged with the threaded shank 28 to further reinforce the respective anchor bolt 24.

The arcuate undercuts 218 each produces a bottom surface portion 246, that as depicted is co-planar with a bottom annular rim 248 defined by the edge 214 and a bottom annular rim 252 defined by the edge 216. This produces a depth HD between a plane P1 containing the surface portions 246 and rims 248, 250 and an underside surface portion 254 on a top wall portion 256 of the flange 206. The depth dimension HD is adequate to accept the axial dimension of the head piece 73 on the anchor bolt 24, whereby the head piece 73 does not extend below, or significantly below, the plane P1. With the body 208 overlying the support surface 12 on the closet collar flange 18, the head piece 73 is vertically captively held.

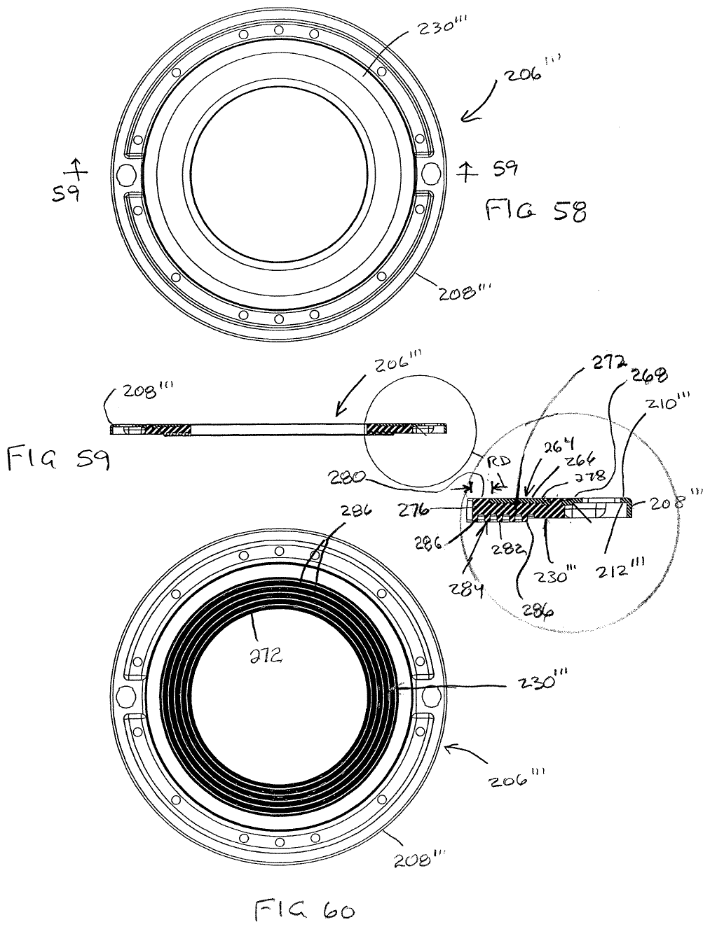

Separate anchor bolts 24 can be operatively connected to the repair flange 206 at diametrically opposite locations thereon, as shown in FIGS. 50-52 and 54-56.

The repair flange 206 with the attached anchor bolts 24 is then aligned with the existing flange 18 and secured by fasteners 224 extending through the repair flange 206, the flange 18 on the closet collar 16, and into the support 12.

A separate seal 258, shown as a ring-shaped component, made commonly from wax, is axially aligned with the repair flange 206 and placed against the top surface 210 of the repair flange 206. The toilet 10 is then lowered to allow the anchor bolts 24 to be directed through the openings 30 on the mounting portion 32 of the toilet. The protruding portions of the anchor bolts 24 can be engaged with components as described above to fix the toilet 10 with respect to the support 12.

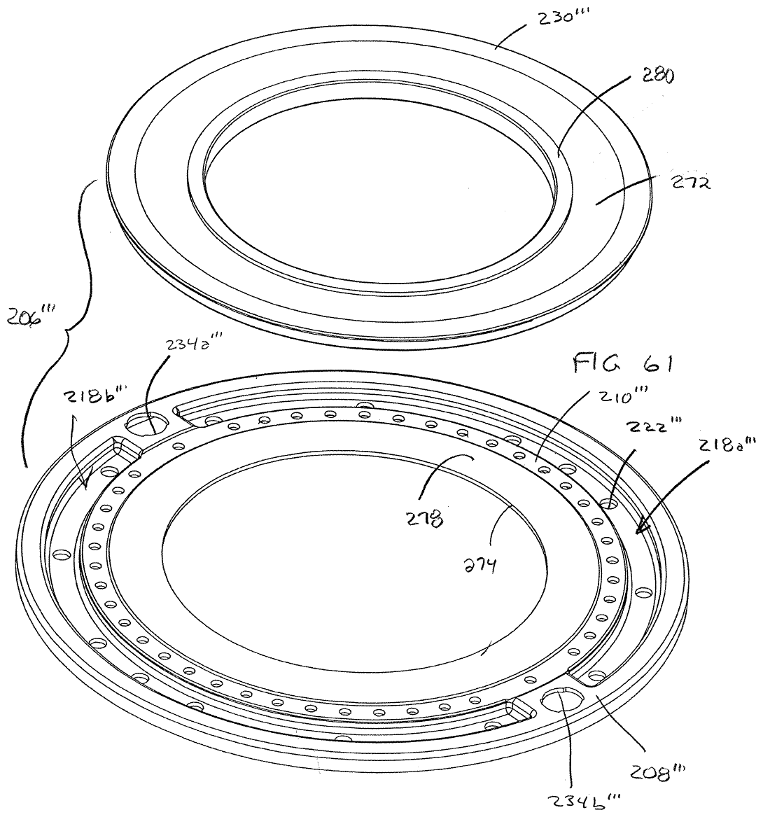

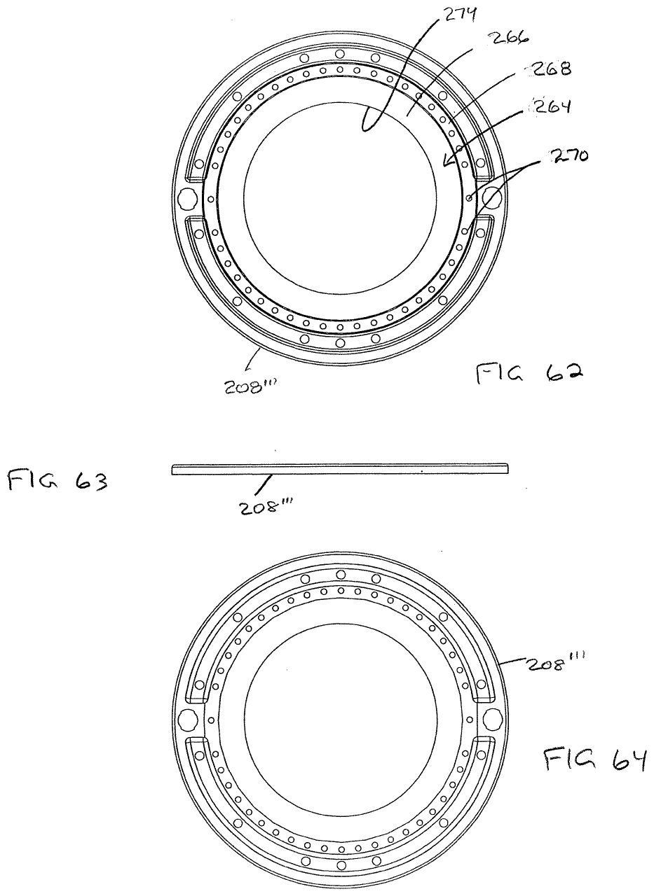

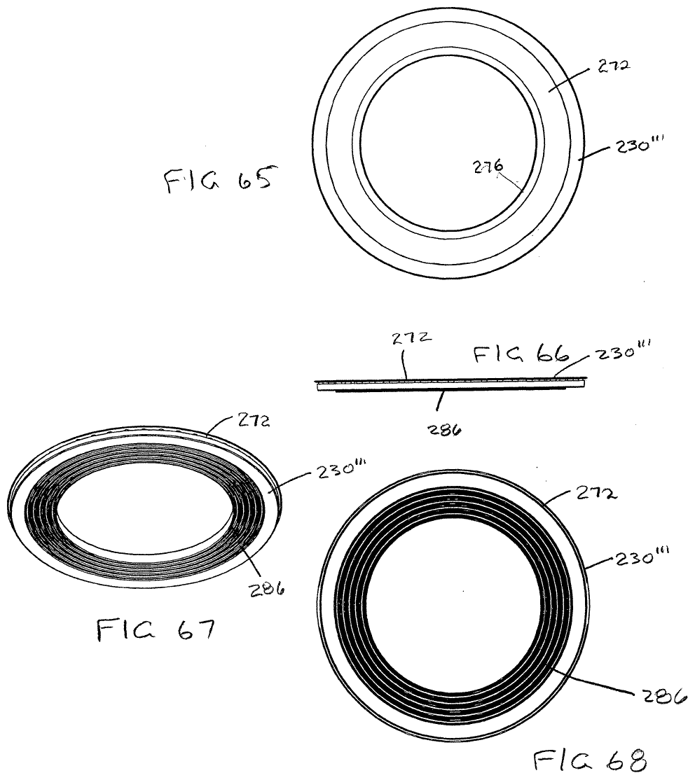

A modified form of repair flange is shown at 206″ in FIGS. 57-68.

The repair flange 206″ has a body 208″ having circumferentially spaced, arcuate undercuts 218a″, 218b′″ corresponding to the arcuate undercuts 218 on the repair flange 206. Appropriate fasteners are directed through openings 222″ within the undercuts 218a″, 218b″ to fix the body 208″ to an underlying closet collar or support surface, as previously described.

The body 208″ has through openings 234a″, 234b″ to accommodate anchor bolts 24, 24′ in the same manner as the aforementioned openings 234a, 234b on the repair flange 206.

Instead of providing a separate sealing component, such as the sealing component 230, at the bottom of the body 208′ “, a suitable sealing material is molded over the body 208” to define a sealing configuration/component 230″ performing the function of the sealing component 230 on the repair flange 206.

Radially inside of the arcuate undercuts 218a″, 218b″ on the body is an annular wall 264 with a substantially flat profile including a radially inside annular portion 266 that is substantially uninterrupted, and a radially outside annular portion 268 having circumferentially spaced openings 270 therethrough.

Forming molds are configured so that the material of the sealing component 230″ produces an annular body 272 with a stepped axial thickness. The body 272 extends radially inwardly from an inside edge 274 of the body 208″ to produce a bead portion 276 with a radial dimension RD.

The material of the body 272 flows into the openings 270 such that the thickness of the annular wall 264 becomes embedded in the material making up the body 272, with the top 278 of the wall on the body 208″ substantially flush with the top 280 of the body 272, as seen clearly in FIG. 59.

The bottom 282 of the body 272 has a stepped configuration with an axially thickened region at 284 defined by a plurality of concentric, annular ribs 286, which are radially spaced from each other to provide relief volumes that facilitate compression of the ribs 286 so that they might create a positive seal with a surface against which the ribs 286 are placed.

The ribs 286 may be the primary sealing structure or, alternatively, an additional sealing component may be placed between the ribs 286 and a cooperating surface, as on a support surface or an underlying flange on a closet collar in the event the repair flange 206″ is used in conjunction with a pre-existing closet collar.

The invention also contemplates that a component might be over-molded to produce a sealing component configuration performing the function of the component 258 used in conjunction with the repair flange 206.

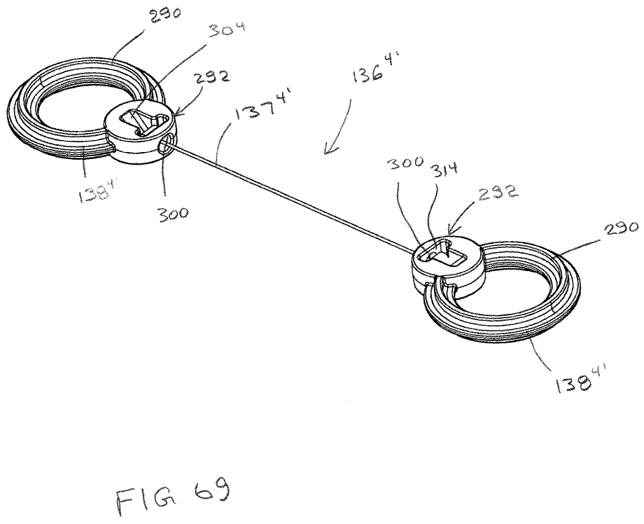

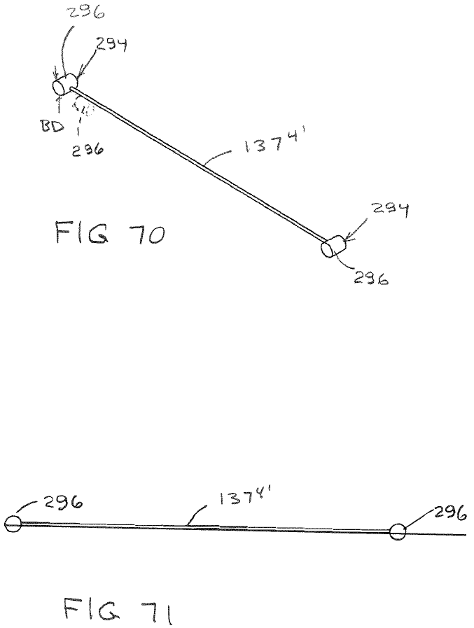

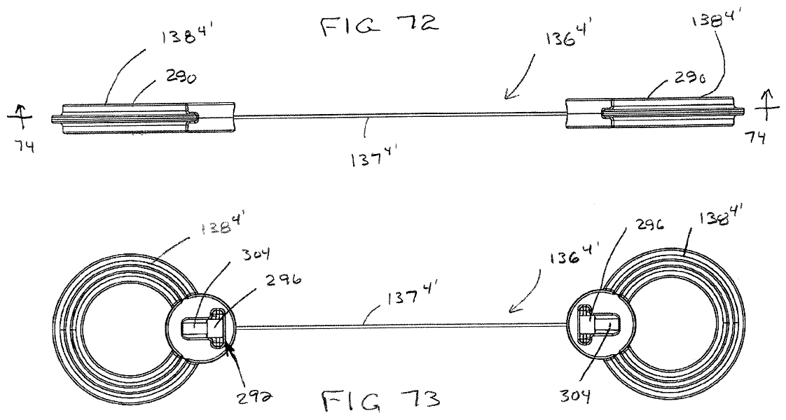

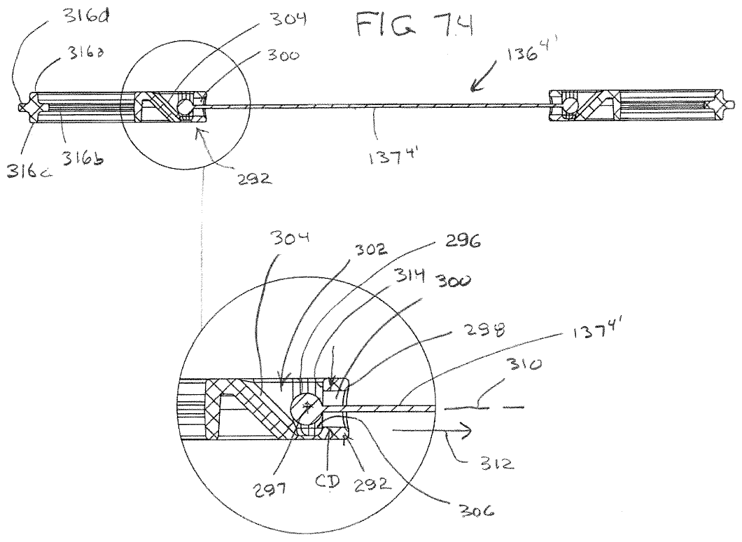

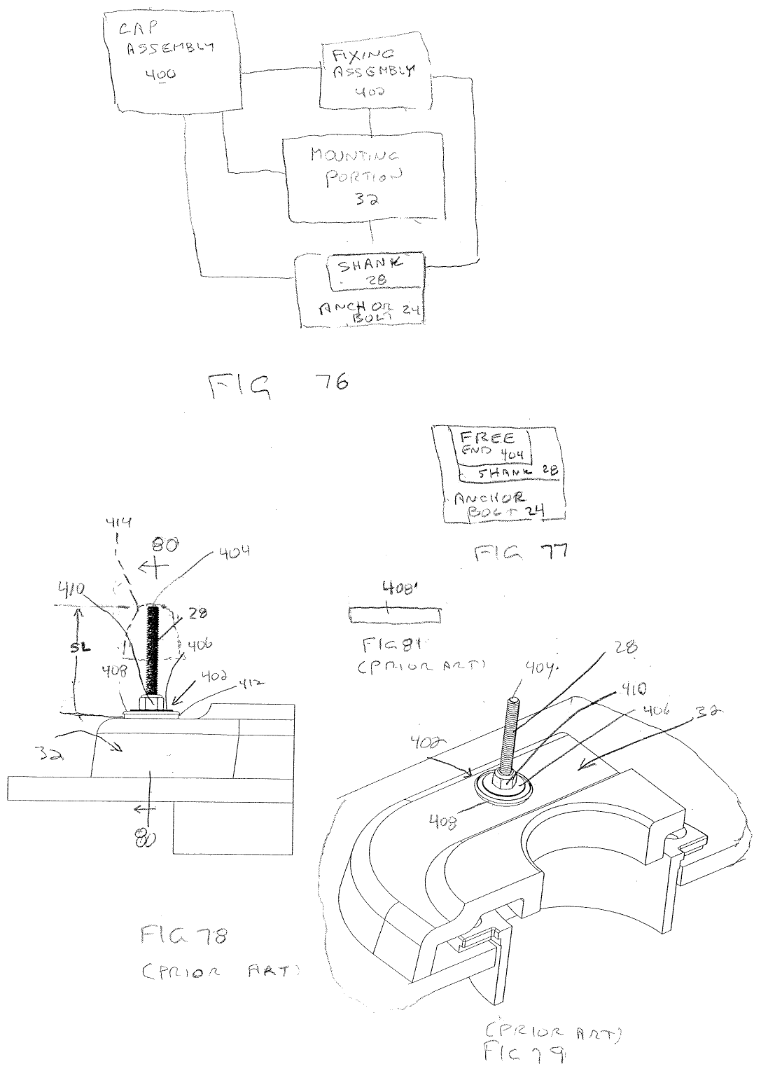

In FIGS. 69-74, a modified form of the cutting tool 136, as shown in FIGS. 24 and 25, is shown at 1364′.

The basic function of the cutting tool 1364′ is substantially the same as that of the cutting tool 136.

The cutting tool 1364′ has an elongate flexible cutting element 1374′ and spaced gripping elements/loops 1384′ that can be held, one each in opposite hands, to allow the flexible cutting element 1374′ to be drawn back and forth against an anchor bolt shank, as described using the cutting tool 136 in FIG. 25.

Instead of lengthening the cutting element 1374′ adequately to allow it to be doubled back upon itself to form the gripping elements/loops 1384′, ring-shaped bodies 290 are attached to a length of the elongate flexible cutting element 1374′.

More specifically, each of the bodies 290 has a connector 292, configured to cooperate with one of like connectors 294 at spaced ends of the flexible cutting element 1374′. The connectors 292 may be integrally formed with a respective body 290 or separately attached thereto.

Each connector 294, while not required to be the same, has a cylindrical body 296. To join the connectors 292, 294, the cutting element 1374′ is locally bent so that the body 296 rests against the elongate flexible cutting element 1374′, as shown in dotted lines in FIG. 70, with the axis 297 of the cylindrical body 296 generally parallel to the abutted length of the cutting element 1374′. In this assembly state, the abutting body 296 and elongate flexible cutting element 1374′ collectively occupy an effective diameter slightly greater than the diameter BD of the body 296-increased by the diameter of the cutting element 1374.

The connector 292 has a wall portion 298 with an opening 300 therethrough with an effective diameter CD slightly greater than the effective diameter of the abutted body 296 and flexible cutting element 1374′.

The opening 300 is in communication with a cavity 302 bounded by a ramp surface 304 and a base surface portion 306 at the bottom of the ramp surface 304.

The elongate flexible cutting element 1374′, at least at the region where the body 296 is located, tends towards a relaxed state as shown in FIG. 70. By placing the body 296 in the dotted line position of FIG. 70, the body 296 and abutted length of the cutting element 1374′ can be directed through the opening 300 in the wall portion towards the ramp surface 304. Once the body 296 resides fully within the cavity 302, the deforming pressure on the elongate flexible cutting element 1374′ is released, whereupon the solid line state of FIG. 70 is reassumed, with the axis 297 of the cylindrical body 296 substantially orthogonal to the axis 310 of the opening 300.

By exerting a tensile force upon the elongate flexible cutting element 1374′ in the direction of the arrow 312 in FIG. 74, the body 296 bridges the opening 300 at the wall portion 298 and exerts a pressure against a confronting surface 314 therearound.

Accordingly, the cutting tool 1364′ lends itself to being used with a shorter elongate flexible cutting element 1374′. At the same time, elongate flexible cutting elements with different constructions/makeup may be interchangeably connected to the spaced gripping elements/loops 1384′, depending upon the particular cutting characteristics and cutting length desired.

The elongate flexible cutting element 1374′ can be separated from the gripping elements/loops 1384′ by reversing the assembly steps—by moving the body 286 to the dotted line position of FIG. 70 and drawing the connector 294 on the elongate flexible cutting element 1374′ away from its respective gripping element/loop 1384′.

As depicted, but not required, each body 296 fits loosely into its respective cavity 302. In the event that the body 296 shifts towards or upwardly along the ramp surface 304, reapplication of the force in the direction of the arrow 312 upon the elongate flexible cutting element 1374′ causes the body 296 to be guided back into the FIG. 74 position.

In this embodiment, each of the bodies 290 is made with arcuate ribs 316a, 316b, 316c, 316d spaced around the central axis of the ring shape that, as depicted, produce a “T” shape in cross-section (see FIG. 74) and collectively provide positive gripping edges to facilitate manipulation of the cutting tool 1364′.

A method of mounting a toilet to a support surface according to the invention is shown in flow diagram form in FIG. 75.

As shown at block 320, a system, as described above, is obtained.

As shown at block 322, the anchor bolt is operatively connected to the closet collar. This may be done on site or the anchor bolt may be integrally formed with the closet collar.

As shown at block 324, the closet collar is anchored relative to the support surface for the toilet.

As shown at block 326, the toilet is directed towards the support surface so that the anchor bolt elongate shank is directed upwardly into a through opening on a mounting portion of the toilet and so that the free end region of the anchor bolt elongate shank projects to above a top surface of the mounting portion of the toilet.

As shown at block 328, the nut assembly body is engaged with the free end region of the anchor bolt shank and positioned to cause the nut assembly body to directly or indirectly exert an axial force on the top surface of the mounting portion of the toilet to thereby place the nut assembly body in a fully connected position.

With the nut assembly body in a fully connected position, the cap is placed in the fully assembled relationship with the cap support assembly as shown at block 330.

The method may further include a step of severing the anchor bolt elongate shank to remove a discrete length thereof to redefine the free end region of the anchor bolt shank.

This severing step may be carried out as described above using the cutting tool 136, the cutting tool 1364′, or a different tool.

The anchor bolt portions made from a non-metal material may be made from nylon or other material. With the anchor bolt 24, the head portion 26 can be integrally molded with the shank 28.

The stabilizing component 78 usable with the anchor bolt 24 will preferably have a height and width limited to approximately 0.5 inches to avoid projection above the surface 46 of the mounting portion 32 of the toilet 10 where it could potentially interfere with the nut assembly 94 threadably engaged with the shank 28.

A wider dimension might not pass without interference into the opening 30 on the mounting portion 32 of the toilet.

The nut assembly 94 may be made from a reinforced nylon material, acetol, POM, EBS, or other plastic or metal materials. The elongate flexible element 137 on the cutting tool 136, as with the elongate flexible element 1374′ on the cutting tool 1364′, may be a wire component with an abrasive bonded thereto via electroplating, glue, or other method of attaching abrasive. The abrasive can be diamond, carbide, or other type of abrasive. The wire can be braided or single strand. Braiding can be used to vary the thickness of wire and provide texture to improve cutting action. The wire can also be a single wire or braided strands of steel, copper, brass, stainless, or other materials that can withstand the pull force and friction while cutting.

As shown in FIG. 25, wire can be braided in a way that it creates a ridge R extending along the length thereof. The apex of the ridge R provides a rougher surface than standard straight braided wire, functioning similarly to a toothed cutting edge on a saw blade.

With the cutting tool 136, the gripping elements 140, 142 may have rubber plastic tubes or handles to provide extra comfort to the hands or fingers of the user during cutting operation. The wire can be coupled together near the loop connections with a crimp fitting 144 to hold each end of the wire around the loop. The act of pulling the wire back and forth across the bolt provides friction, allowing the wire to pull through the bolt and therefor cutting the bolt to a desired height.

The cap may be made from plastic material, such as polypropylene, ABS, or other plastic. Alternatively, it could be produced in a porcelain or metal material, as can be appreciated.

The anchor bolts can be made from nylon, polyamide, thermal plastic urethane (TPU), isoplast, or other suitable materials. The material may be 10-40% glass filled for added strength. Any of the non-metal materials described above may be used for any of the component parts that are made from a non-metal material.

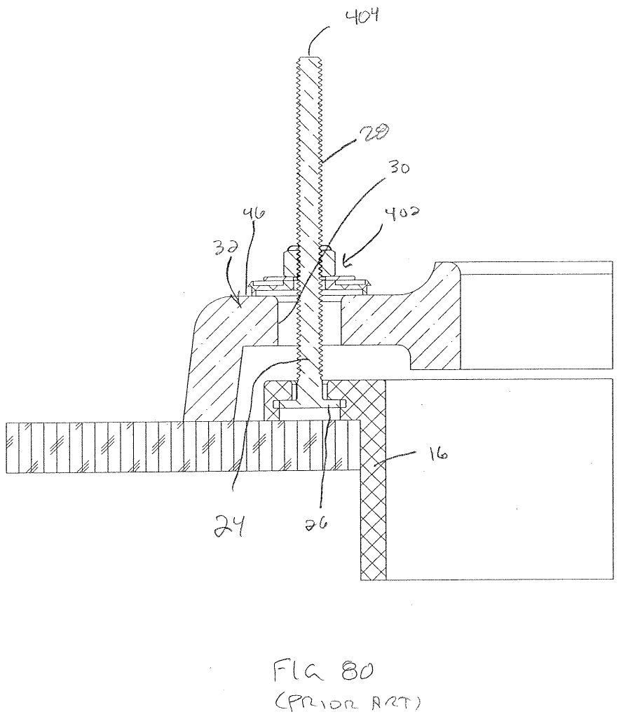

The invention contemplates a multitude of different structures to perform the basic function of the cap 40, notably overlying and blocking from view structure exposed above the surface 46 of the mounting portion 32 which is provided at spaced locations to anchor the mounting portion 32 and maintain the operative position of the toilet. As described hereinbelow, and as shown schematically in FIG. 76, a cap assembly 400 is in different forms provided for aesthetic purposes and/or to perform additional functions.

As shown in FIG. 76, the structure with which the cap assembly 400 cooperates typically consists of the mounting portion 32, the anchor bolt 24 with the elongate shank 28, and a fixing assembly 402 that engages the shank 28 so as to block movement of the mounting portion along a length of the shank 28, including the aforementioned free end region 38, to beyond a free end 404 of the anchor bolt shank 28, as shown schematically in FIG. 77. The anchor bolt 24 may be made from a metal or non-metal material.

The precise structure making up the fixing assembly 402 is not in any way limited in terms of configuration and number of components.

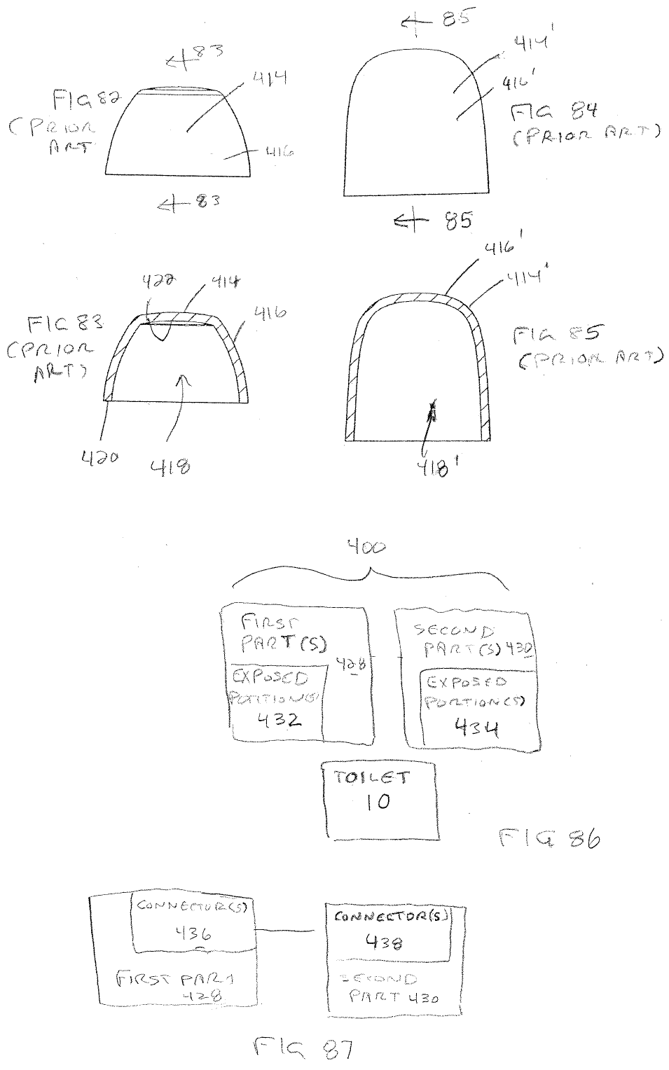

As but one example, as shown in FIGS. 78-80, a conventional fixing assembly at 402 consists of an upper washer 406, an underlying washer 408, and a nut 410 that is threaded down the elongate shank 28 to, in conjunction with the head portion 26 of the anchor bolt 24, capture the toilet mounting portion 32.

Typically, the upper washer 406 will be made from metal, with the underlying washer 408 made from a non-metal material. In the depicted form, the underlying washer 408 has a peripheral flange 412, described hereinbelow as optionally used with a cap assembly 400 to allow snap-fitting of components.

Alternatively, as shown in FIG. 81, the underlying washer 408′ may be made without the flange 412.

As noted, any number of washers or other components might be utilized to be borne against by the nut 410 to produce the requisite captive holding force for the mounting portion 32. More than the one nut 410 might also be used.

Without limitation, and as shown clearly in FIG. 80, the anchor bolt 24 has a head portion 26, which is captured between the closet collar 16 and an underlying surface, with the mounting portion 32 in turn captured between the head portion 26 and the fixing assembly 402. An important feature is that there is some structure extending to beyond, and in this case above, the mounting portion surface 46, thereby remaining visible in the vicinity of the opening 30 through which the anchor bolt 24 extends with the toilet in the operative position.

In FIGS. 82 and 83, one conventional form of cap 414 is disclosed with a simple inverted cup-shaped wall 416. The wall 416 bounds a cavity 418 which is designed to accept any mounting/anchoring components extending to beyond the mounting portion surface 46. The diameter of the cavity 418 is selected to be greater than the effective diameter of, in this case, the washers 406, 408.

The height of the cavity 418 must be greater than a projecting length SL (see FIG. 78) of the shank 28 to allow a rim surface 420 at the entry to the cavity 418, to rest against, or closely adjacent to, the mounting portion surface 46.

As shown in FIGS. 78-81, the projecting length SL of the shank 28 is greater than the height of the cavity 418, whereby a surface 422 at the base of the cavity 418 abuts the free end 404 of the shank 28, before the rim surface 420 can seat, whereupon the cap 414 becomes suspended in the position as shown in dotted lines in FIG. 78.

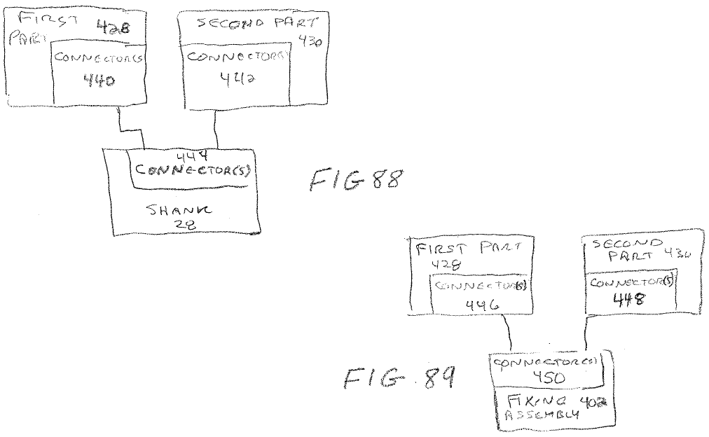

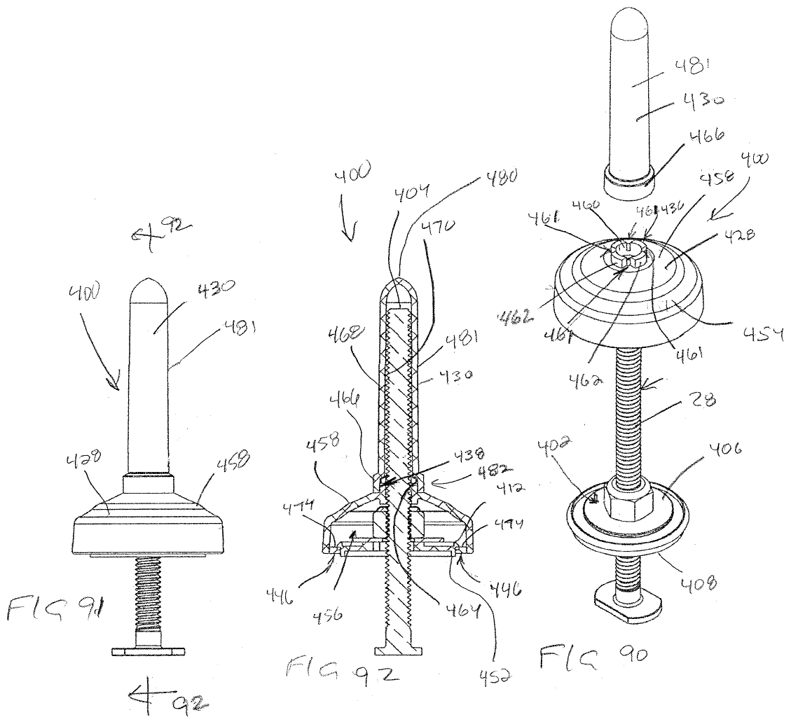

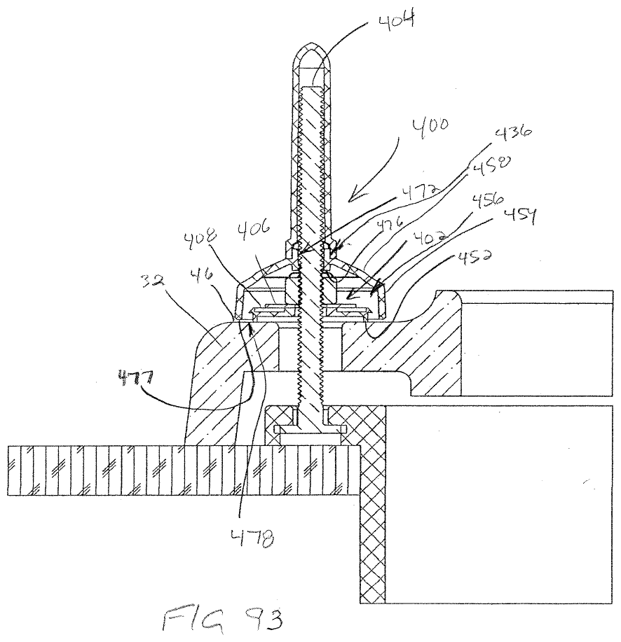

An alternative form of the cap in FIGS. 82 and 83 is shown at 414′ in FIGS. 84 and 85. The cavity 418′ defined by cap 414′ is deeper than the cavity defined by the cap 414 to thereby accommodate longer projecting shank lengths. At some point, the depth of the cavity 418′ and the height of the wall 416′ become impractically large, whereby the cap 414′ becomes an obtrusive structure that interferes with cleaning of the toilet, is often unsightly, and is prone to being inadvertently impacted and separated from the toilet 10.

One exemplary form of the inventive cap assembly 400 is shown schematically in FIG. 86 and consists of at least a first part 428 and at least a second part 430. The first and second parts 428, 430 are placed in an assembled and operative state with respect to the toilet 10 wherein at least one exposed portion 432 of the first part 428 and at least one exposed portion 434 on the second part 430 cooperatively overly and block from view at least portions of the elongate shank 28 and fixing assembly 402.

The assembled and operative state for the first and second shielding parts 428, 430 may be achieved in several different manners.

The first and second parts 428, 430 may be releasably or permanently connected directly or indirectly to each other.

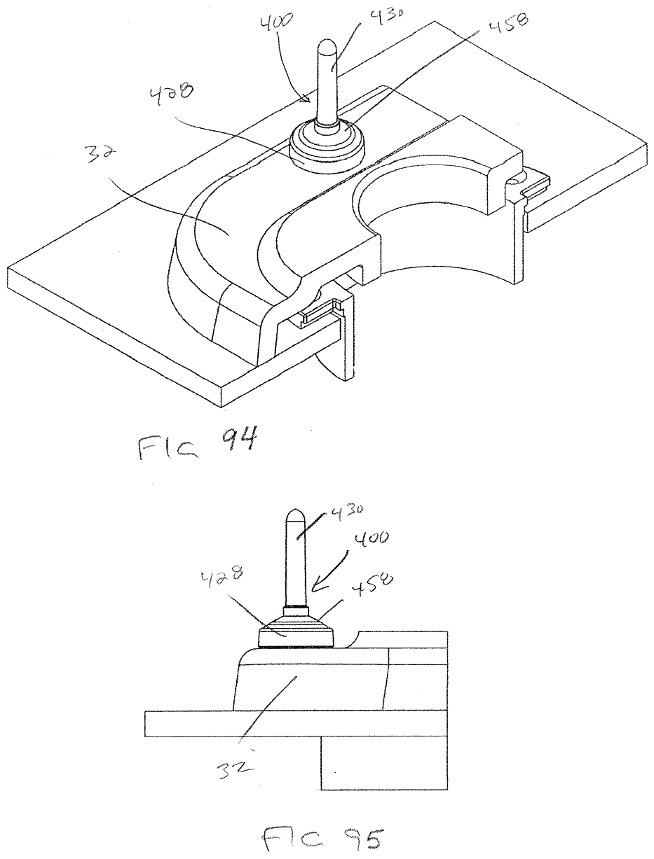

As shown in FIG. 87, at least one connector 436 on the first part 428 may cooperate with at least one connector 438 on the second part 430 to effect a permanent or releasable connection.

As shown in FIG. 88, one or more connectors 440 on the first part 428 and/or one or more connectors 442 on the second part 430 may cooperate with one or more connectors 444 on the elongate shank 28.

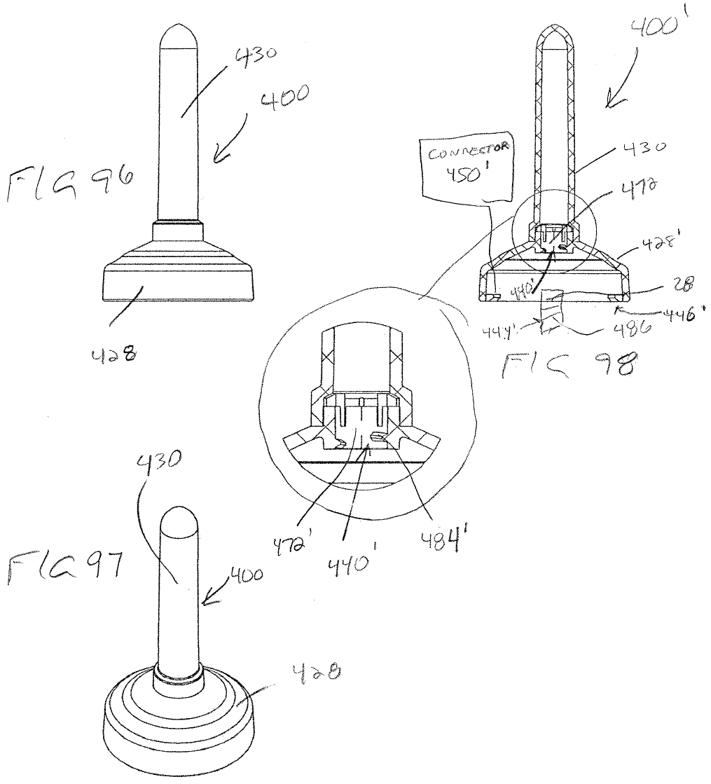

In an alternative form, as shown in FIG. 89, one or more connectors 446 on the first part 428 and/or one or more connectors 448 on the second part 430 may cooperate with one or more connectors 450 on the fixing assembly 402.

It is contemplated that a single pair of cooperating connectors may maintain the assembled and operative state for the first and second parts 428, 430 or that any combination of the cooperating connectors, including less than, or all of, those disclosed herein, may be utilized to maintain the assembled and operative state for the first and second parts 428, 430.

As noted, the assembled and operative state for the first and second parts 428, 430 may be realized with the first and second parts 428, 430 either directly or indirectly connected to each other.

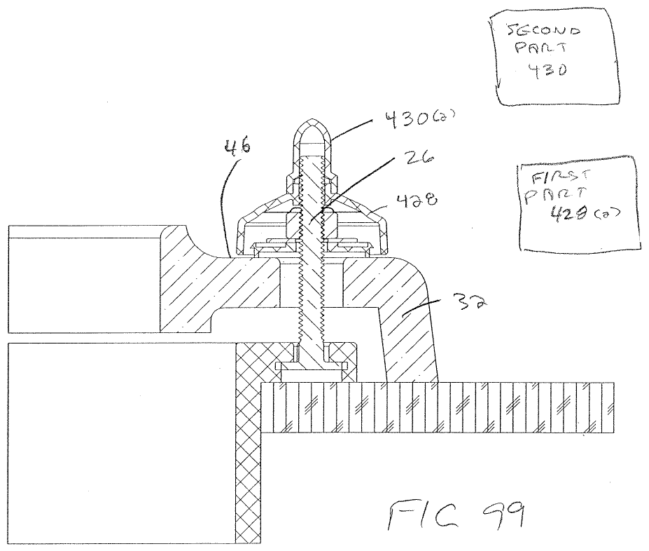

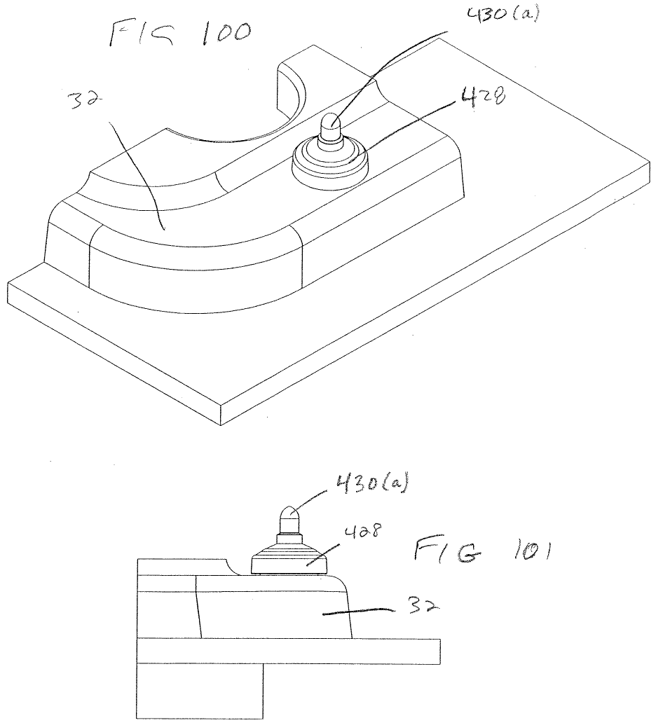

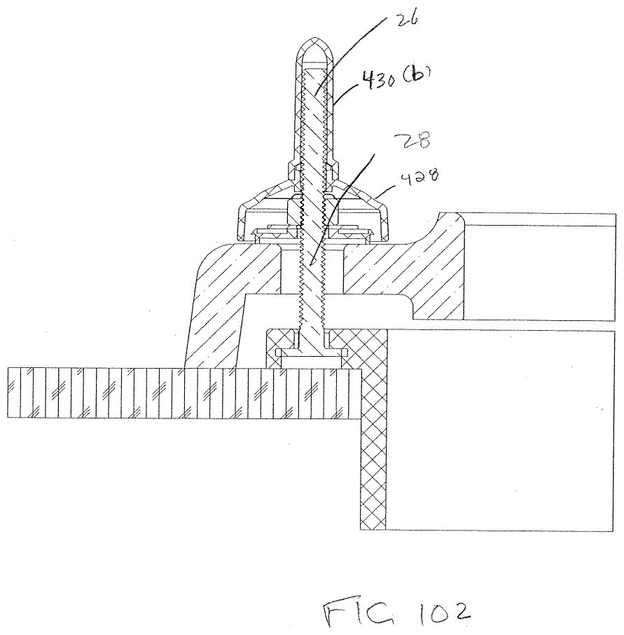

A first exemplary form of the cap assembly 400 is shown in FIGS. 90-97. It should be emphasized that the designations “first” and “second” as used herein to define the parts 428, 430, is an arbitrary designation to facilitate the description herein, with the understanding throughout that the designation “first” and “second” may be reversed.

In this embodiment, the fixing assembly 402 is as shown in FIGS. 78-80, consisting of the upper washer 406 and the underlying washer 408 that has an annular seat 452 designed to abut the surface 46 on the mounting portion 32.

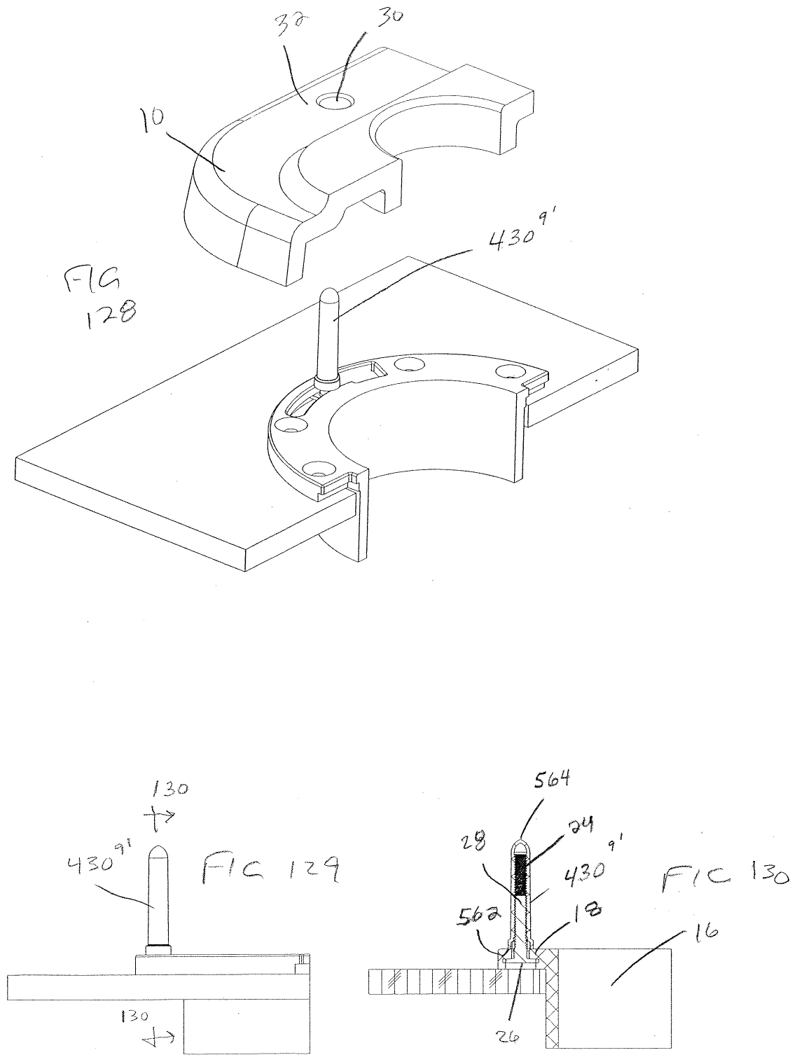

The first part 428 has an inverted, cup-shaped wall 454 defining a cavity 456 to accommodate a majority, and in this case substantially the entirety, of the fixing assembly 402 with the first and second parts 428, 430 in the assembled state of FIGS. 90-92 and the assembled and operative state in FIGS. 93-95. The wall 454 preferably has a diameter adequate to also cover the ofttimes elongate opening 30 through the mounting portion 32, as seen in FIG. 128. It is also contemplated that the cavity 456 may actually receive only a limited volume of the fixing assembly 402 and still perform a valuable function in terms of aesthetics and also deflecting foreign matter by reason of there being in the depicted form a convex outer surface 458 on the wall 454.

In this embodiment, there is a connector 436 on the first part 428 that cooperates with a connector 438 on the second part 430.

The connector 436 is in the form of an annular rim 460 that projects upwardly from the wall 454. The rim 460 is interrupted at spaced circumferential locations 461 producing individual tabs 462 that can flex slightly.

The connector 438 is in the form of an annular seat 464 defined at a thickened portion 466 of a wall 468 on the second part 430.

By axially aligning the rim 460 and seat 464, the rim 460 can be advanced into the seat 464 to the assembled relationship shown clearly in FIGS. 91 and 93. The rim 460 and seat 464 can be relatively dimensioned so that the rim 460 is slightly radially deformed during assembly such that restoring forces in the tabs 462 produce additional frictional holding forces between the first and second parts 128, 130, to adequately maintain their assembled state using a simple press-fitting process.

The first and second parts 428, 430 can be separated if desired by reversing the assembly step. Alternatively, the first and second parts 428, 430 might be permanently joined.

The wall 468 bounds a cylindrical cavity 470 which is slightly greater in diameter than the diameter of the shank 28 along most or all of its axial extent so that the wall 468 conformingly surrounds the shank 28.

The wall 454 and rim 460 cooperatively define a throughbore 472 to receive the shank 28. With the wall 454 in the FIG. 90 relationship with the projecting length of the shank 28, the wall 454 can be lowered, which causes the free end 404 of the shank 28 to advance into and from the throughbore 472. The wall 454 can then be slid along the shank 28 up to, or adjacent to, the surface 46 on the mounting portion 32.

In this embodiment, the first part 428 has connectors 446 defined by in-turned, circumferentially spaced, ramped tabs 474 that cooperate with the flange 412 to produce a camming action as the first part 428 is lowered towards the FIG. 91 position. This camming action causes one or both of the flange 412 and tabs 474 to deflect until the tabs 474 pass beyond and reside below the flange 412, whereupon the deformed parts spring back to produce a snap-fit connection. This structure also assists centering/alignment of the first part 428. Details of an exemplary snap-fit connection that might be used are shown in U.S. Pat. No. 9,909,296, the disclosure of which is incorporated herein by reference.

With the above structure, the first and second parts 428, 430 can be changed from their FIG. 90 relationship into the assembled and operative state in different manners.

For example, the first part 428 can be snap-fit into its FIG. 91 position, whereupon the wall 468 on the second part 430 can be slid guidingly down the exposed length of the shank 28 and press fit to the first part through the cooperating connectors 436, 438.

Alternatively, the first and second parts 428, 430 may be press fit together before being placed over the projecting exposed length of the shank 28.

The details of precisely how the first part 428 seats, or aligns, in relationship to the mounting portion 32 and fixing assembly 402 are not critical to the invention. As seen in FIG. 93, a depending rim portion 476 may abut to the nut 410 to arrest downwardly movement of the first part 428. Alternatively, an annular bottom rim 477 on the first part 428 may abut to the surface 46 of the mounting portion 32 before that occurs. In this case, a slight gap at 478 remains between the rim 477 and the surface 46 of the mounting portion 32. The first part 428 may alternatively be only frictionally held in place.

The parts 428, 430 are dimensioned so that the wall 468 on the second parts 430 extends upwardly to at least the free end 404 of the shank 28, and above that location tapers and is rounded at a free end 480 for aesthetics and to avoid hanging up on persons or objects moved thereagainst.

The precise configuration of the walls 454, 468 may vary significantly from the configurations shown. What is desirable is that the exposed outer surface portions 458, 481, respectively on the first and second parts 428, 430, cooperatively overly and block from view significant portions of the elongate shank 28 and the fixing assembly 402.

The close surrounding of the shank 28 by the wall 468 on the second part 430 facilitates guided movement therealong. This configuration is not required.

As seen in FIG. 91, the connectors 436, 438 interact at a location at 482 at a mid-length portion of the shank 28. A portion of the first part 428 extends away from the location 482 in a direction away from the free end 404 of the shank 28, while a portion of the second part 430 extends away from the location 482 in a direction towards the free end 404 of the shank 28. In other words, with the first and second parts 428, 430 in an assembled state, the cooperating connectors 436, 438 interact at a location that is spaced from each of the ends of the combined structure of the first and second parts 428, 430 along the axis of the shank 28.

The overall combined shape of the first and second parts 428, 430 has a stepped outer diameter in relationship to the axis of the shank 28. The effective outer diameter of the wall 454 is preferably at least twice the effective outer diameter of the wall 468. If the wall surface 481 is tapered, it is still preferred that its average effective diameter be significantly less than the diameter of the wall 454.

As depicted, the first part 428 and second part 430 are readily distinguishable by their different diameters, with the second part 430 projecting in cantilever fashion away from the first part 428.

In an alternative form of cap assembly, as shown at 400′ in FIG. 98, the second part 430 is configured the same as in FIGS. 90-97. The first part 428′ has the same general configuration as the first part 428, in terms of how it cooperates with the second part 430 and the fixing assembly 402, and additionally has a connector 440′ that cooperates with a connector 444′ on the shank 28. As depicted, the connector 440′ is in the form of threads 484′ around a throughbore 472′, corresponding to the throughbore 472, which threads cooperate with threads 486 on the shank 28 which make up the connector 444′.

The threads 484′ in this embodiment, and corresponding threads in other embodiments, may extend either fully, or only partially, around a respective bore. There may also be spaced threaded regions, with one or more unthreaded region therebetween. The threads may be formed on rigid parts or parts that flex. In the latter case, translation between parts with mating threads is permitted to make a gross relationship change, after which the mating threads re-engage.

The threads may be configured to match all typical anchor bolt sizes—¼-20, 5/16″, ⅜″, etc.

In this embodiment, the first part 428′ is threadably connected with the shank 28 and turned to be advanced therealong until it forces the snap connection of the connector 446′, corresponding to the connector 446, with the connector 450′, corresponding to the connector 450.

The inclusion of connectors, corresponding to the connectors 446, 446′, is not required for any first part 428, nor is any type of snap-fit connection of any first part 428.

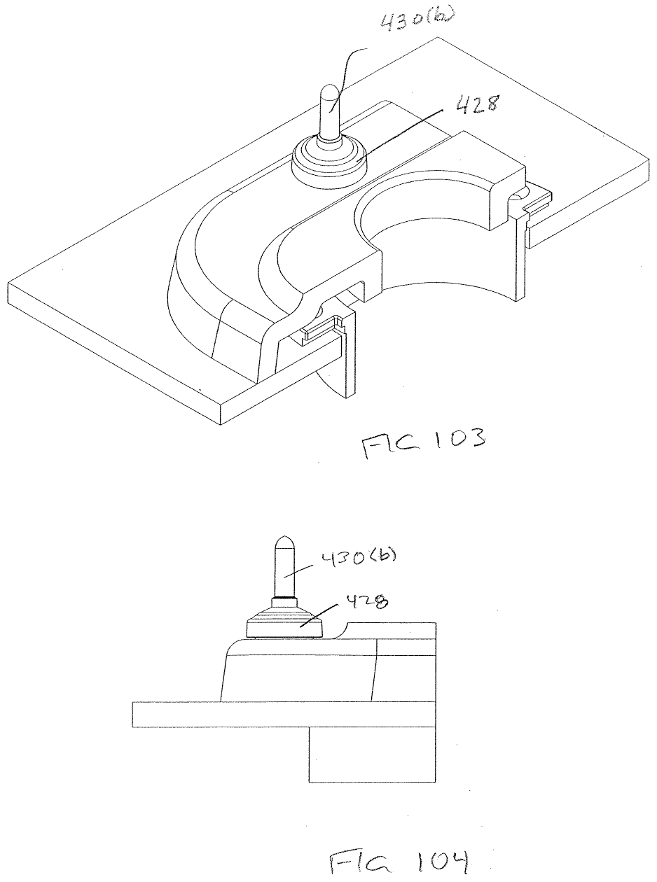

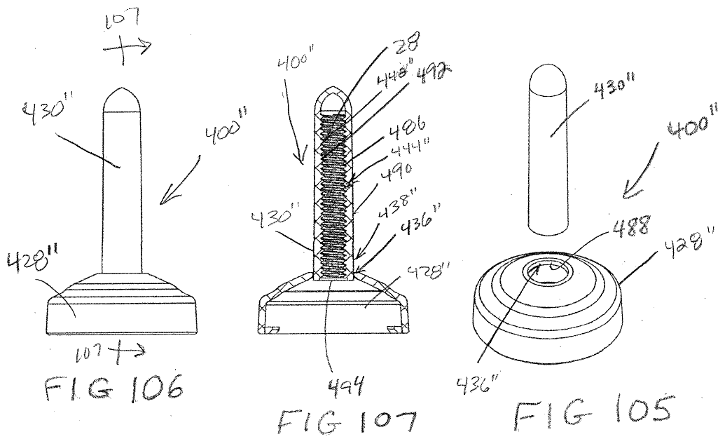

As shown in FIGS. 99-101, a third part 430 (a) can be provided in combination with the first and second parts 428, 430 to produce a kit. The second part 430 (a) interacts with the first part 428 in substantially the same way that the second part 430 cooperates therewith. The exemplary, depicted third part 430 (a) has the same overall configuration as the second part 430, with the exception that the third part 430 (a) is dimensioned to closely accommodate a shorter projection of the anchor bolt shank 28 from the mounting part surface 46, as can be seen by comparing FIG. 93 and FIG. 99.

Thus, as seen in FIGS. 99, one may obtain the first part 428 and the interchangeable second parts 430, 428 (a). At the installation site, a user can select and assemble the appropriate second part.

It is also contemplated that the kit may include another form of the first part 428 (a) that is different than, and interchangeable with, the first part 428.

The interchangeable parts, usable one in place of the other, are different by reason of one of at least: a) having a different size; b) having a different shape; c) having a different color; and d) having a different appearance.

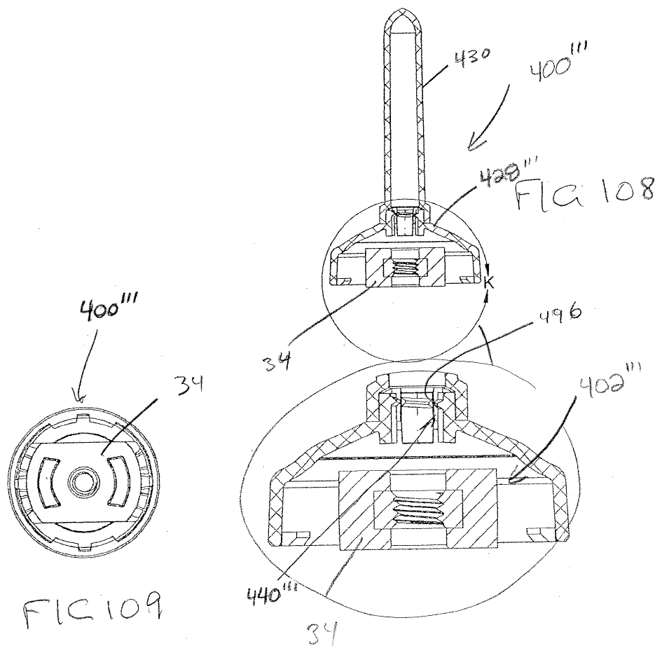

In FIGS. 102-104, an additional part 430 (b) is shown that is interchangeably usable with the first part 430, 430 (a). The part 430 (b) interacts with the first part 428 in the same manner that the part 430 cooperates therewith. The main difference between the part 430 (b) and the parts 430, 430 (a) is that the part 430 (b) has an axial dimension that is in-between the axial dimensions of the parts 430, 430 (a), to closely accommodate the projecting length of the shank 28, as shown in FIG. 102, that is less than the projecting length of the shank 28 in FIG. 93, and greater than the projecting length of the shank 28 in FIG. 99.

It should be understood that the interchangeability of parts is contemplated for all parts as described herein, including those with different connector arrangements, etc.

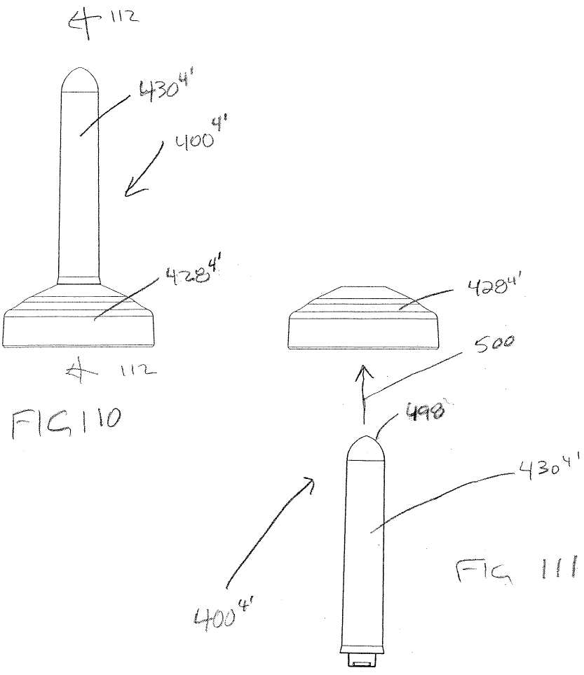

In FIGS. 105-107, a further modified form of cap assembly is shown at 400″. The cap assembly 400″ is made up of a first part 428″ and a second part 430″.

The first part 428″ is similar to the first part 428, described above, with one distinction being that with the first and second parts 428″,430″ in the assembled state of FIG. 106, the connector 436″ on the first part 428″ is in the form of a thin rim 488 that closely surrounds an outer surface 490 on the second part 430″, making up the cooperating connector 438″. The second part 430″ is threadably connected to the shank 28, whereby internal threads 492 on the second part 430″ make up a connector 442″, with the threads 486 making up a cooperating connector 444″.

With this configuration, the first part 428″ can be snap fit into place, after which the second part 430″ is threadably engaged with the shank 28 and advanced downwardly until the bottom edge 494 of the second part 430″ is adjacent to, or penetrates, the rim 488.

The diameters of the rim 488 and outer surface 490 may be relatively dimensioned to allow the second part 430″ to be engaged with the shank 28 before the first part 428″ is advanced over the associated fixing assembly 402, whereupon the first part 428″ can be slid guidingly downward along the outer surface 490 of the second part 430″ until the assembled and operative state for the first and second parts 428″,430″ is realized.

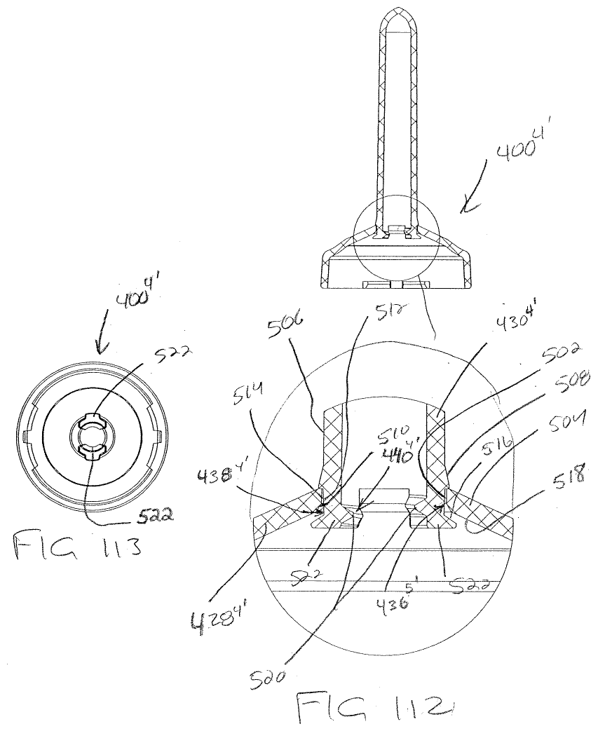

A further modified form of cap assembly is shown at 400″ in FIGS. 108 and 109 adapted to a fixing assembly 402″ which includes the cap support assembly 34, as described above.

The cap assembly 400′″ utilizes the form of the second part 430, as described above, with this not being a requirement.

The first part 428″ is similar to the first part 428′, described above, with a main difference being that threads 496, making up the connector 440″ are located axially above where the corresponding threads 484 are located on the first part 428′.

In some environments, to avoid ready access by children to discrete small parts that might create a swallowing risk, it is desirable to strengthen the connection between the first and second parts 428, 430.

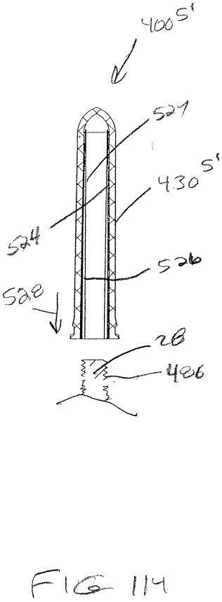

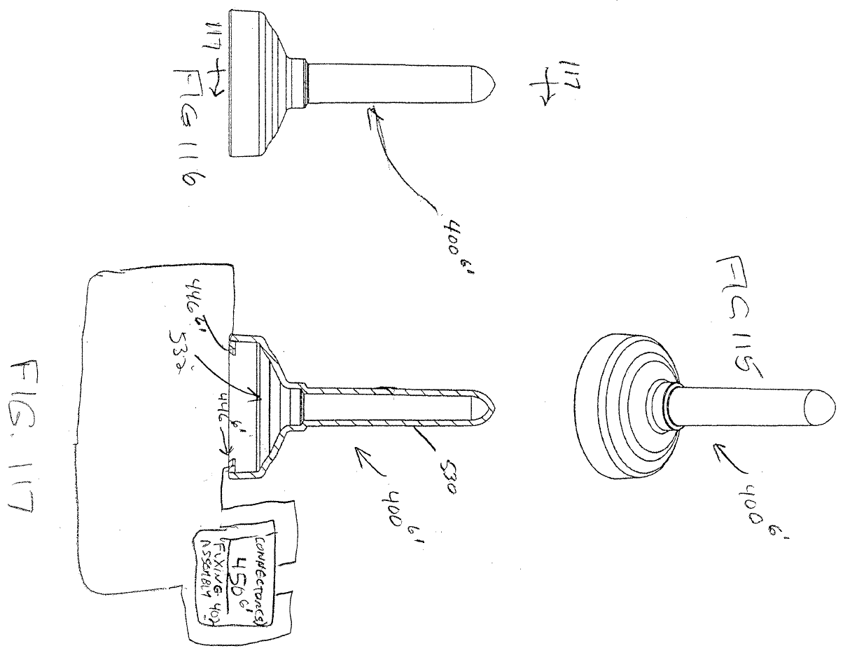

In one form of cap assembly, as shown at 4004 in FIGS. 110-113, the first and second parts 4284, 4304′ are configured so that the second part 4304′ is directed through the first part 4284′ in a bottom-to-top direction to place the parts 4284, 4304′ in their assembled state, as shown in FIGS. 110 and 112.

The second part 4304′ has a tapered leading end 498 that guides the second part 4304, in the FIG. 111 orientation, in the direction of the arrow 500 into an opening 502 through a wall portion 504 on the first part 4284′. The diameter of the opening 502 is dimensioned to closely surround the outer surface 501 of the second part 4304 which can be slid guidingly therethrough.

The trailing region of the advancing second part 4304′ has a radially enlarged cam surface 508 that interacts with a cam surface 510 on the wall portion 504. As the surfaces 508, 510 interact, the second part 4304′ and/or wall portion 504 around the opening 502 deform to allow the cam surface 508 to move upwardly fully past the wall portion 504 to the FIG. 112 position. Once the FIG. 112 position is realized, the interacting parts that are deformed during assembly tend back towards their original shape, which causes the rim surface 512 bounding the opening 502 to seat in an annular undercut 514 at the trailing region of the advanced second part 4304′.

An annular bead 516 at the trailing end of the advanced second part 4304′ abuts to the underside 518 of the wall portion 504 to block further upward movement of the second part 4304′ that would otherwise allow it to be separated from the first part 4284′.

The undercut 514 defines a connector 4384′ on the second part 4304′ that cooperates with a connector 4364′ defined by the wall portion around the opening 502.

The second part 4304′ has threads 520 produced cooperatively by tabs 522, which make up a connector 4404′, that cooperate with threads on a shank 28 making up a cooperating connector.

As noted above, in this and other embodiments, the formation of the threads may be on deflectable tabs which allow the first and second parts 428, 430 to be relatively moved translationally and thereafter turned to engage the tabs for controlled advancement. In each case, the incorporation of tabs is an option. Alternatively, the threads may be continuous. Further, there may be threaded regions that are spaced axially from other threaded regions, with unthreaded regions therebetween.

As an alternative to using the discrete threads, with or without tabs, a threaded connection can be effected as shown, for example, on the cap assembly 4005′ in FIG. 114. A second part 4305′, corresponding to the second part 4304, is provided. Rather than having the aforementioned discrete threads, one or more discrete, axially extending, formable ribs 524 is provided within a wall cavity portion 526 to receive an anchor bolt shank 28. With this arrangement, the second part 4305′ can be translated axially along the shank 28 as indicated by the arrow 528. The threads 486 on the shank 28 compressibly deform the ribs 524 as this occurs. There is enough elasticity in the ribs 524 that once the translational movement occurs and thereafter stops, the second part 4305′ can be turned relative to the shank 28 to effectively reestablish a threaded connection. This feature facilitates efficient installation.

It should be understood that each of the cap assemblies 400, as described hereinabove, might be made as a single piece as opposed to being made from the first and second parts 428, 430, and potentially one or more additional parts.

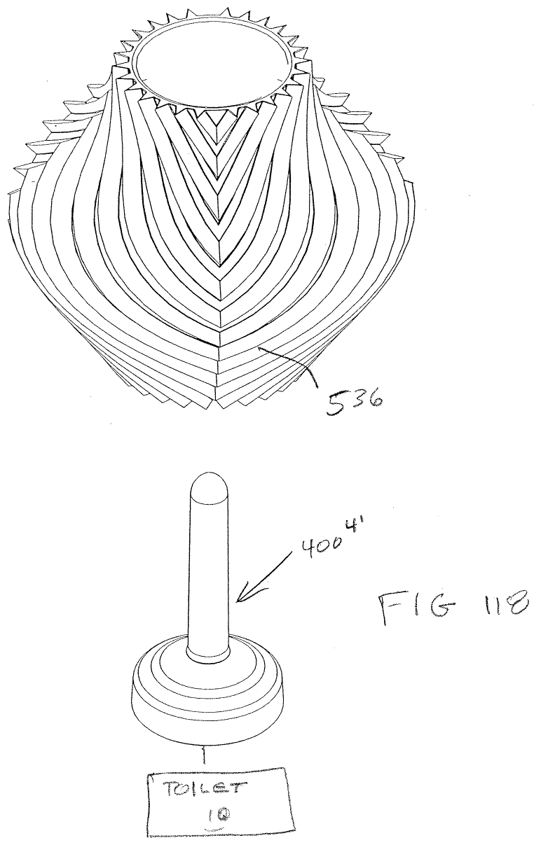

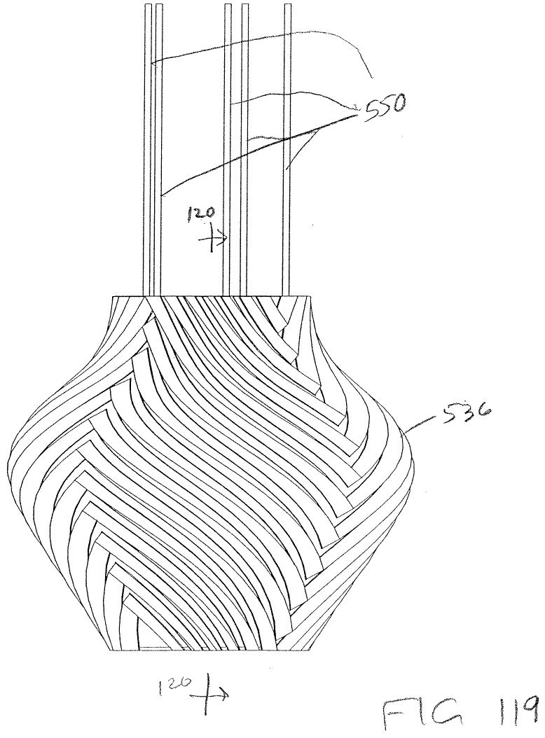

As seen in FIGS. 115-117, a cap assembly 4006′, having the basic configuration of the cap assembly 400 in FIGS. 90-92, is shown made as one piece. The cap assembly 4006′ is shown with a wall 530 having essentially the same external appearance as the wall produced cooperatively by the wall portions defined by each of the first and second parts 428, 430 on the cap assembly 400.

Similarly, a single cavity 532 has substantially the same shape as that of the combined cavity portions defined by the first and second parts 428, 430 making up the cap assembly 400. For clarity herein, the cooperating wall portions on the first and second parts 428, 430 may be considered to be a single wall defining a single cavity.

In the depicted embodiment for the cap assembly 4006′, connectors 4466′, as shown on the first part 428 on the cap assembly 400, are provided to cooperate with connectors 4506′ on the fixing assembly 402.

With the one-piece cap assemblies snap fit or otherwise held in an operative state, they lend themselves to aligning or reinforcing the position of one or more additional components. The same stability may be arrived at with the two-part construction, particularly with, but not limited to, the construction shown in FIGS. 110-114.

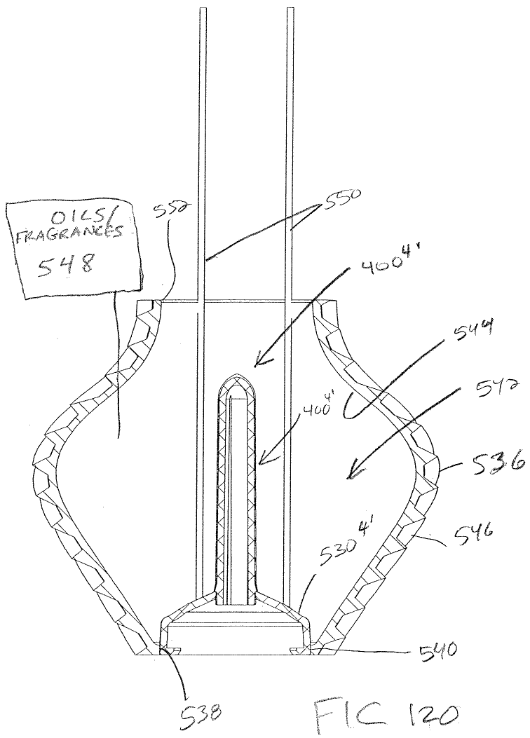

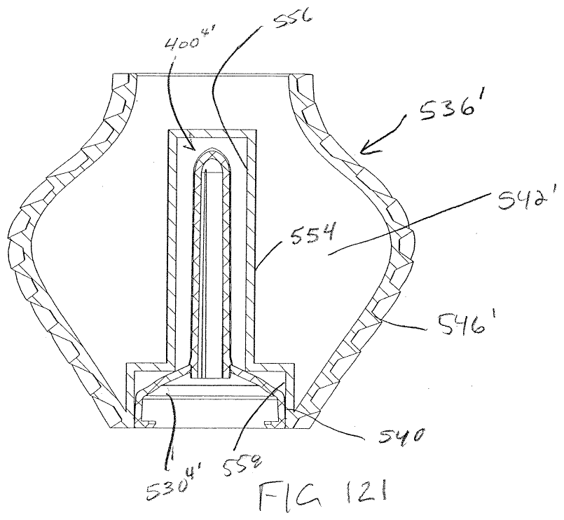

More specifically, as shown in FIGS. 118-120, a vessel 536 can be placed in an operative position with respect to a toilet 10 by being engaged with the exemplary cap assembly 4004′ operatively connected therewith. As depicted, the vessel 536 has a bottom opening bounded by a rim 538 which can surroundingly engage an outer surface region 540 at the lower region of the first part 5304′. A close connection between the rim 538 and outer surface 540 creates a sealed chamber at 542 bounded cooperatively by the cap assembly 4004′ and an inside surface 544 of a wall 546 on the vessel 536.

Within this chamber 542, a supply of essential oils/fragrances 548 might be placed. To disperse the oils/fragrances 548 within a space, one or more diffuser rods 550 may be directed through a top vessel opening 552 and into the supply of the oils/fragrances 548.

A modified form of vessel is shown at 536′ in FIG. 118. The vessel 536′ differs from the vessel 536 primarily by reason of having a wall configuration that produces a self-contained, sealed chamber 542′ independently of the cap assembly 4004′. This is made possible by forming the wall 546′ to include an inside wall portion 554 that bounds a sub-chamber 556 within which the cap assembly 4004′ resides. The inside wall portion 554 has a depending rim 558 that surrounds the outer surface 540 of the first part 5304′ to stabilize the position of the vessel 536′ in relationship to the cap assembly 4004′ and the toilet 10 on which the cap assembly 4004 is situated.

Whereas the second parts 430, described above, have been generally compact, with a small outside volume that overlies portions of the shank 28 and fixing assembly 402 to block them from view, a corresponding second part may be configured to be placed in an assembled and operative state, as in prior embodiments, but may additionally have more artistic three-dimensional shapes that enhance aesthetics and create a more interesting look at areas of the toilet that heretofore has been generally visually unappealing. While not explained in detail herein, the first parts 428 may also be adorned and shaped for aesthetic purposes.

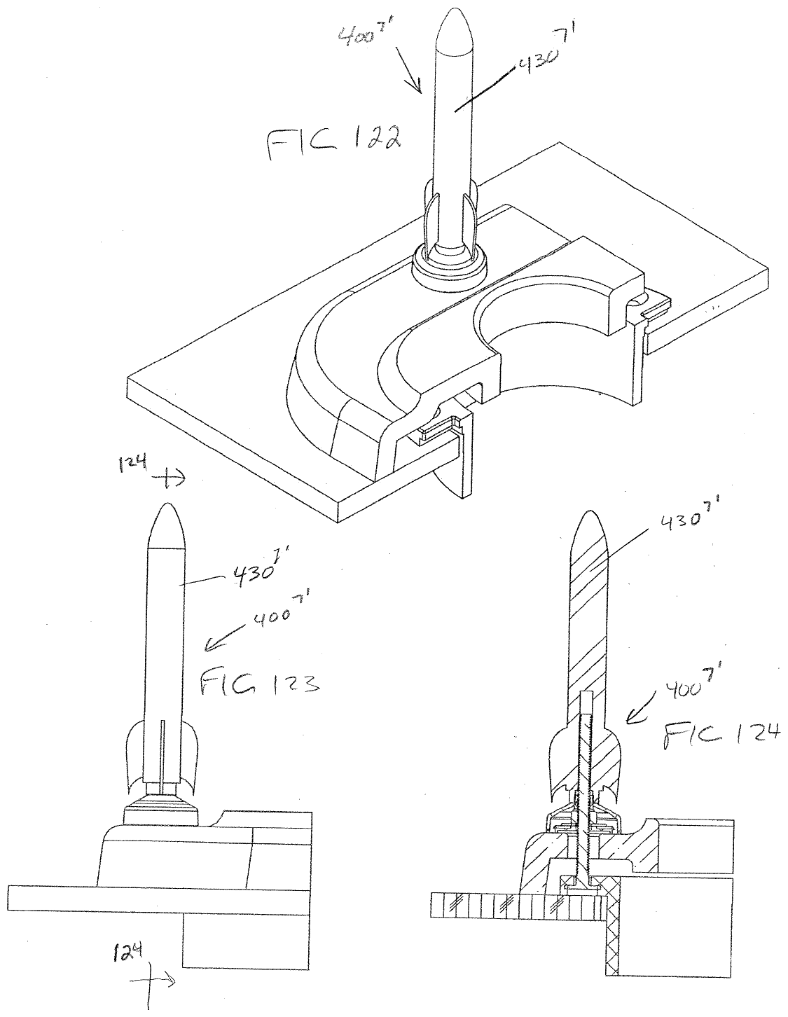

As shown on the cap assembly 4007 in FIGS. 122-124, the second part 4307 is connected in the same manner that the second part 430, described above, is connected to the first part 428, but has at least a portion with a three-dimensional shape depicting part or all of an identifiable object. In this case, the identifiable object is a rocket ship. The identifiable object can take virtually an unlimited number of different shapes and forms. Preferably, at least part of the second part 4307 has a three-dimensional shape that imitates the appearance of a three-dimensional identifiable object.

A bathroom for a child may have a sports theme, a dinosaur theme, a ballerina them, or a Disney character theme. As an added décor accent, a figurine can be placed over the fixing assembly 402. The inside of the figurine can be hollowed out, allowing the figurine to nest over the outside of the fixing assembly 402, and held in place. Various figurines could be offered as decoration options. For example, dogs, cats, turtles, birds, or any other style figurine that would be desired to improve bathroom aesthetics.

The figurine could be cored out on the inside to match a generic long anchor bolt shank 28, or it could be designed around specific, shorter projecting shank lengths. The figurine could be made from ceramic, blow molded plastic, injection molded plastic, 3D-printed material, or any other material that can be molded, cast, or carved. The figurine, while shown as depicting an identifiable three-dimensional object, may also be another form of artistic shape involving aesthetic features beyond a simple cover shape.

A cavity may be formed in the figurine to nominally match the projecting anchor bolt shank 28 and/or fixing assembly 402. Alternatively, the figurine cavity may accommodate a cap assembly 400 or a part thereof. Keying structure/components may act between the figurine and underlying supporting structure to maintain a consistent angular orientation of the figurine. This keying structure may be on the toilet 10, the anchor bolt 24, and/or the fixing assembly 402.

Alternatively, or additionally, the keying structure on the figurine may be externally of the cavity on the figurine.

The keying structure may be engaged as an incident of lowering the figurine in place and/or by another action, or actions, involving, without limitation, turning, translation in another path, etc.

A dedicated keying element may be added to cooperate with at least one keying element on the figurine.

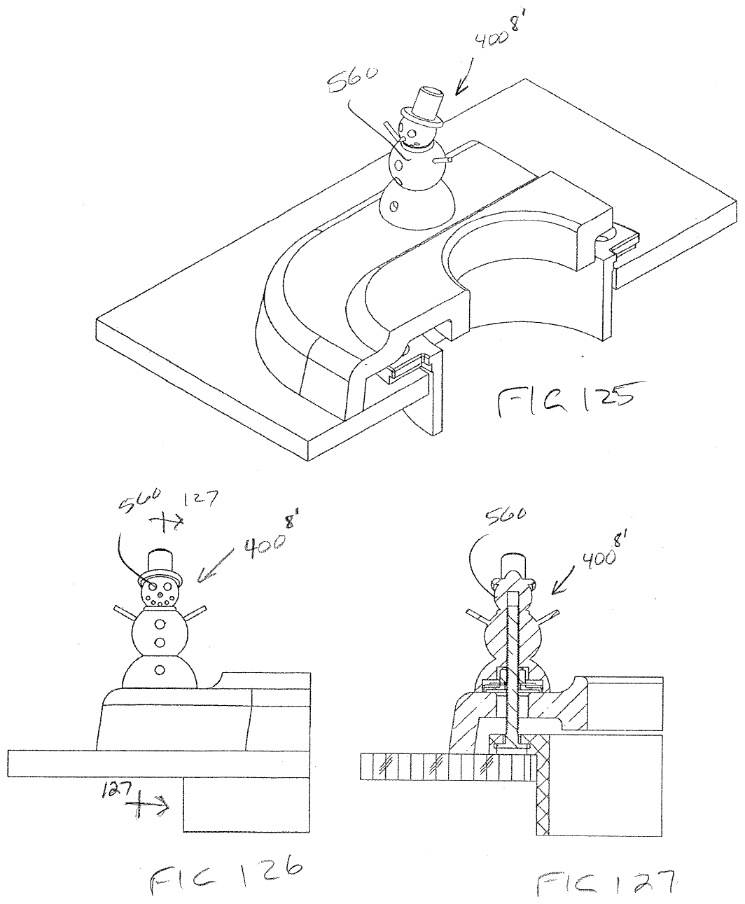

In FIGS. 125-127, a further form of cap assembly, according to the invention, is shown at 4008′. The cap assembly 4008′ is made as one piece corresponding to the configuration of the cap assembly 4006′.

The cap assembly 4008′ essentially performs as the cap assembly 4006′ but incorporates an ornamental wall/wall portion 560 that incorporates a depiction of a three-dimensional object—in this case a snowman.

Independently of the shielding and decorative functions of the cap assemblies 400, described above, a part at 4309′ with the same general shape as shown for the part 430 in FIGS. 90-92, can be used to facilitate the initial placement of the toilet 10, as shown with reference to FIGS. 128-130. More specifically, the part 4309′ can be threaded over the anchor bolt shank 28 to capture a flange 18 on a closet collar 16 between the anchor bolt head portion 26 and an annular rim 562 at the bottom of the part 4309′. This stabilizes the shank 28 on the anchor bolt 24 in an upright position, as shown in each of FIGS. 128-130. This facilitates alignment of the tapered upper end 564 into the opening 30 in the mounting portion 32 of the toilet 10.

Use of the part 4309′ may obviate the need to use longer anchor bolts to facilitate alignment during installation, which longer bolts must be severed or otherwise accommodated to avoid leaving exposed unsightly anchoring components.

Once the toilet is seated, the part 4309′ can be unthreaded and separated. Preferably, the diameter of the opening 30 is adequate to allow the part 4309′, once separated from the anchor bolt 24, to be drawn upwardly through and from the opening 30.

All parts of the cap assemblies can be injection molded or 3D printed. Alternatively, they could be cast or made using any other form of molding or production. The material can be PP, ABS, or other injection grade or 3D printed grade material. The material ideally is resistant to household cleaning chemicals.

The foregoing disclosure of specific embodiments is intended to be illustrative of the broad concepts comprehended by the invention.

1. A cap assembly for use with a toilet mounted in an operative position on a support and maintained in the operative position using at least one anchor bolt having an elongate shank that projects into a mounting portion on the toilet so that a free end of the elongate shank is exposed, a fixing assembly engaging the elongate shank so as to block movement of the mounting portion along a length of the elongate shank to beyond the free end of the elongate shank, the cap assembly comprising:
first and second parts that are placed in an assembled and operative state wherein exposed portions on each of the first and second parts cooperatively overlie and block from view at least portions of the elongate shank and the fixing assembly.

2. The cap assembly according to claim 1 wherein the first and second parts are connected to each other.

3. The cap assembly according to claim 1 wherein the first and second parts are releasably connected to each other.

4. The cap assembly according to claim 1 wherein there are cooperating connectors on one of the first and second parts and the elongate shank.

5. The cap assembly according to claim 1 wherein there are cooperating connectors on one of the first and second parts and the fixing assembly.

6. The cap assembly according to claim 4 wherein there are cooperating connectors on the other of the first and second parts and the fixing assembly.

7. The cap assembly according to claim 6 wherein there are cooperating connectors on the other of the first and second parts and the elongate shank.

8. The cap assembly according to claim 2 wherein there are cooperating connectors on the first and second parts at a first location along the length of the elongate shank, a portion of one of the first and second parts extends away from the first location and the other of the first and second parts towards the free end of the elongate shank and a portion of the other of the first and second parts extends away from the first location and the one of the first and second parts away from the free end of the elongate shank.

9. The cap assembly according to claim 2 wherein with the first and second parts in the assembled state, the cap assembly has first and second ends spaced along the length of the elongate shank and there are cooperating connectors on the first and second parts that interact at a location spaced from each of the first and second ends of the cap assembly.

10. The cap assembly according to claim 1 wherein the first and second parts are directly connected to each other through cooperating connectors configured to make a releasable press fit connection.

11. The cap assembly according to claim 2 wherein the first and second parts are directly connected to each other.

12. The cap assembly according to claim 4 wherein the cooperating connectors are configured to be threadably engaged.

13. The cap assembly according to claim 4 wherein the cooperating connectors are configured to be press fit together.

14. The cap assembly according to claim 1 wherein one of the first and second parts has a wall that has a cup shape defining a cavity in which at least a portion of the fixing assembly resides.

15. The cap assembly according to claim 14 wherein the other of the first and second parts has a substantially cylindrical outer surface extending around a length portion of the elongate shank.

16. The cap assembly according to claim 15 wherein the wall has an effective outer diameter in relationship to a lengthwise axis of the elongate shank, the substantially cylindrical outer surface has an effective average diameter and the effective outer diameter of the wall is at least two times greater than the effective outer diameter of the cylindrical outer surface.

17. The cap assembly according to claim 1 wherein one of the first and second parts has a cylindrical wall which conformingly surrounds a length portion of the elongate shank and an end wall that overlies the free end of the elongate shank.

18. The cap assembly according to claim 1 wherein one of the first and second parts projects in cantilever fashion from the other of the first and second parts.

19. The cap assembly according to claim 1 wherein the first and second parts are directly connected to each other through cooperating connectors configured to make a snap-fit connection.

20. The cap assembly according to claim 1 wherein one of the parts has a three-dimensional depiction of an object thereon.

21. The cap assembly according to claim 1 in combination with a third part, that is interchangeably usable in place of one of the first and second parts, the third part different than the one of the first and second parts by reason of at least one of: a) having a different size; b) having a different shape; c) having a different color; and d) having a different appearance.

22. The cap assembly according to claim 1 in combination with the toilet, the at least one anchor bolt, and the fixing assembly.

23. A first cap assembly for use with a toilet mounted in an operative position on a support and maintained in the operative position using at least one anchor bolt having an elongate shank that projects through a mounting portion on the toilet so that a length portion of the shank extending above the mounting portion up to a free end of the elongate shank is exposed, a fixing assembly engaging the elongate shank so as to block movement of the mounting portion along a length of the elongate shank to beyond the free end of the elongate shank, the first cap assembly comprising:
a wall defining a cavity into which at least a part of each of the fixing assembly and the length portion of the elongate shank is received with the first cap assembly in an operative state,
the wall having a stepped outer diameter with a larger diameter portion and a smaller diameter portion, the smaller diameter portion projecting away from the larger diameter portion in a direction towards the free end of the elongate shank.

24. The first cap assembly according to claim 23 wherein the smaller diameter portion extends up to the free end of the shank and overlies the free end of the elongate shank.

25. The first cap assembly according to claim 23 wherein the smaller diameter portion conformingly surrounds at least a part of the length portion of the elongate shank.

26. The first cap assembly according to claim 23 wherein the smaller diameter portion is threadably engaged with the elongate shank.

27. The first cap assembly according to claim 25 wherein the smaller diameter portion has a substantially uniform thickness.

28. The first cap assembly according to claim 23 in combination with a second cap assembly that is usable interchangeably in place of the first cap assembly, the second cap assembly different than the first cap assembly by reason of at least one of: a) having a different size; b) having a different shape; c) having a different color; and d) having a different appearance.

29. The first cap assembly according to claim 28 wherein the second cap assembly having a wall with a stepped outer diameter with a larger diameter portion and a smaller diameter portion, the smaller diameter portion on the second cap assembly projecting away from the large diameter portion of the second cap assembly in a direction towards the free end of the elongate shank, the smaller diameter portions on the first and second cap assemblies extending away from respective larger diameter portions distances that are different.

30. The first cap assembly according to claim 29 wherein the first and second cap assemblies in respective operative states overlie the free end of the elongate shank.
